(19) United States
(12) Patent Application Publication
(10) Pub. No.: US 2026/0156133 A1
(43) Pub. Date: Jun. 4, 2026

(54) ANOMALY DETECTION METHOD, ANOMALY DETECTION DEVICE, AND RECORDING MEDIUM

(71) Applicant: Panasonic Intellectual Property Management Co., Ltd., Osaka (JP)

(72) Inventors: Tomoki KAGA, Osaka (JP); Takeshi KISHIKAWA, Osaka (JP); Yoshihiro UJIIE, Tokyo (JP)

(73) Assignee: Panasonic Intellectual Property Management Co., Ltd., Osaka (JP)

(21) Appl. No.: 19/456,552

(22) Filed: Jan. 22, 2026

Related U.S. Application Data
(63) Continuation of application No. PCT/JP2024/027060, filed on Jul. 30, 2024.

(30) Foreign Application Priority Data
Aug. 3, 2023 (WO) PCT/JP2023/028483

(51) Int. Cl. H04L 9/40; H04L 67/12

(52) U.S. Cl. CPC H04L 63/1425; H04L 67/12

(57) ABSTRACT

An anomaly detection method is performed by a higher electronic control unit in an in-vehicle network having a hierarchical structure including a higher network including the higher electronic control unit(s) and a lower network including lower electronic control unit(s). The method includes: collecting flow information including statistical information, for each flow, classified based on header information of each message received at a predetermined observation point in the in-vehicle network; performing anomaly detection based on the flow information; and performing generating, adding, deleting, changing, enabling, or disabling of a DPI rule based on the anomaly detection result. The DPI rule is used in message monitoring by the lower electronic control unit(s). The DPI rule indicates (i) a condition for header information and payload information included in a message, and (ii) processing to be performed when a message satisfying the condition is received.

### CROSS REFERENCE TO RELATED APPLICATIONS

This is a continuation application of PCT International Application No. PCT/JP2024/027060 filed on July 30, 2024, designating the United States of America, which is based on and claims priority of PCT International Application No. PCT/JP2023/028483 filed on August 3, 2023. The entire disclosures of the above-identified applications, including the specifications, drawings and claims are incorporated herein by reference in their entirety.

### DESCRIPTION

### FIELD

The present disclosure relates to a device that detects an anomaly in a communication and to a method for detecting an anomaly in a communication in an in-vehicle network system.

### BACKGROUND

Recent systems for automobiles are provided with a large number of devices each called an Electronic Control Unit (ECU). A network connecting these ECUs is called an in-vehicle network. There are many standards for in-vehicle networks, and one of the most mainstream in-vehicle-network standards is Control Area Network (hereinafter, CAN).

With the recent spread of automated operating and connectivity, it is predicted that a traffic in an in-vehicle network will increase, and in-vehicle Ethernet, which is a standard of communication higher than CAN, is being popularized.

In addition, as an anomaly detection method for monitoring a malicious attacker, for example, the method described in Non Patent Literature (NPL) 1 is known.

### Citation List

### Non Patent Literature

NPL 1: Specification of the IP Flow Information Export (IPFIX) Protocol for Exchange of Flow Information (RFC7011), September 2013, <https://www.rfc-editor.org/rfc/pdfrfc/rfc7011.txt.pdf>

### SUMMARY

### Technical Problem

In such anomaly detection, it is desired to strike an appropriate balance between a detection accuracy and a processing amount, which are in a trade-off relationship.

The present disclosure provides an anomaly detection method, an anomaly detection device, and the like that are capable of striking an appropriate balance between the detection accuracy and the processing amount.

### Solution to Problem

In order to solve the above problem, an anomaly detection method according to an aspect of the present disclosure, which is performed by a higher electronic control unit in an in-vehicle network, the in-vehicle network having a hierarchical structure including a higher network and a lower network, the higher network including one or more higher electronic control units including the higher electronic control unit, the lower network including one or more lower electronic control units, includes: collecting flow information including statistical information for each flow, the flow being classified based on header information of each of messages received at a predetermined observation point in the in-vehicle network; performing anomaly detection based on the flow information; and performing one of generating, adding, deleting, changing, enabling, or disabling of a Deep Packet Inspection (DPI) rule based on a result of the anomaly detection, wherein the DPI rule is used in message monitoring by the one or more lower electronic control units, and the DPI rule indicates (i) a condition for header information and payload information that are included in a message, and (ii) processing to be performed when a message satisfying the condition is received.

### Advantageous Effects

The present disclosure can provide an anomaly detection method, an anomaly detection device, and the like that are capable of striking an appropriate balance between the detection accuracy and the processing amount.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is an overall configuration diagram of an in-vehicle network system according to Embodiment 1.

FIG. 2 is a block diagram of a zone ECU according to Embodiment 1.

FIG. 3 is a block diagram of an ADAS ECU according to Embodiment 1.

FIG. 4 is a diagram illustrating a SOME/IP SD message format according to Embodiment 1.

FIG. 5 is a diagram illustrating one example of a SOME/IP SD message according to Embodiment 1.

FIG. 6 is a diagram illustrating a SOME/IP message format according to Embodiment 1.

FIG. 7 is a diagram illustrating one example of a SOME/IP message according to Embodiment 1.

FIG. 8 is a diagram illustrating one example of flow information collected by the zone ECU according to Embodiment 1.

FIG. 9 is a diagram illustrating one example of an all-DPI-rule list according to Embodiment 1.

FIG. 10 is a diagram illustrating one example of an ECU management list according to Embodiment 1.

FIG. 11 is a diagram illustrating a sequence from collecting flow information to anomaly detection and security response according to Embodiment 1.

FIG. 12 is a flowchart of DPI rule generation processing by the zone ECU according to Embodiment 1.

FIG. 13 is a flowchart of reception processing by a communication port unit according to Embodiment 1.

FIG. 14 is a flowchart illustrating one example of processing by a flow-based anomaly detector according to Embodiment 1.

FIG. 15 is a diagram illustrating one example of an anomaly alert according to Embodiment 1.

FIG. 16 is a flowchart of DPI rule generation processing according to Embodiment 1.

FIG. 17 is a flowchart of DPI rule transfer processing according to Embodiment 1.

FIG. 18 is a diagram illustrating one example of a DPI rule generated from the anomaly alert according to Embodiment 1.

FIG. 19 is diagram illustrating a flowchart of DPI rule processing according to Embodiment 1.

FIG. 20 is a diagram illustrating one example of a DPI alert according to Embodiment 1.

FIG. 21 is a flowchart of DPI alert processing by the zone ECU according to Embodiment 1.

FIG. 22 is a diagram illustrating one example of a DPI rule for disconnecting an anomalous communication according to Embodiment 1.

FIG. 23 is an overall configuration diagram of an in-vehicle network system according to Embodiment 2.

FIG. 24 is an overall configuration diagram of a zone ECU according to Embodiment 2.

FIG. 25 is a diagram illustrating a sequence from collecting flow information to anomaly detection and security response according to Embodiment 2.

FIG. 26 is a flowchart of DPI rule generation processing according to Embodiment 2.

FIG. 27 is a flowchart of processing by a DPI rule transferrer according to Embodiment 2.

FIG. 28 is a diagram illustrating one example of flow information requested to determine an application target of a DPI rule according to Embodiment 2.

FIG. 29 is a table showing one example of a DPI rule generated from an anomaly alert according to Embodiment 2.

FIG. 30 is an overall configuration diagram of an in-vehicle network according to Embodiment 3.

FIG. 31 is a configuration diagram of a zone ECU according to Embodiment 3.

FIG. 32 is a diagram illustrating one example of a security monitoring DPI rule list according to Embodiment 3.

FIG. 33 is a diagram illustrating a sequence from collecting flow information to applying a DPI rule for security monitoring according to Embodiment 3.

FIG. 34 is a flowchart of packet processing by the zone ECU according to Embodiment 3.

FIG. 35 is a flowchart of processing by a safety determiner according to Embodiment 3.

FIG. 36 is a flowchart of processing by a DPI rule generator according to Embodiment 3.

FIG. 37 is a diagram illustrating one example of a DPI rule for security monitoring according to Embodiment 3.

### DESCRIPTION OF EMBODIMENTS

### Underlying Knowledge Forming Basis of the Present Disclosure

Over an in-vehicle network, control frames for giving instructions to cause a vehicle to travel, stop, turn, or perform other actions are sent and received. This raises such a problem that not only a driver of the vehicle but also pedestrians around the vehicle are exposed to danger in a case of the execution of an attack in which a malicious attacker sends control frames while spoofing a proper ECU or a Denial-of-Service (DoS) attack for interfering with the reception of specific control frames.

In an in-vehicle Ethernet environment, which is being popularized, a communication is performed at a higher speed, making it difficult to monitor individual packets by Deep Packet Inspection (DPI), which performs a payload-based monitoring.

For that reason, a specification called IP Flow Information Export (IPFIX), which is described in NPL 1, has been provided as a method for monitoring the whole of a network. In the IPFIX, a plurality of frames flowing through an Ethernet network are classified by an Ethernet switch based on information included in an Ethernet header or a TCP/IP header, to generate statistical information called flow information. The flow information is monitored by an anomaly detection device, which is of a higher rank than the Ethernet switch, and it is thus possible to monitor the whole of network with a low computational cost and a low communication traffic.

Unfortunately, the anomaly detection method using the flow information does not monitor payload information of packets, thus involving the risk of a misdetection and the like.

According to the present disclosure, flow information is generated from statistical information that is collected from header information of packets. Then, a higher anomaly detection device detects an anomaly based on changes over time in the flow information, and a payload-based monitoring rule is enabled for packets that are predicted to be anomalous from a result of the detection. This causes the payload monitoring to be performed on only some of the packets, enabling the detection of an anomaly while reducing misdetections and a computational amount necessary for the monitoring. As a result, it is possible to monitor an anomalous communication in an in-vehicle network while reserving computational resources necessary for processing for automated operating or an advanced driver assistance system.

In other words, in the anomaly detection system for an in-vehicle network according to the present disclosure, an anomaly detection device is in charge of monitoring the whole in-vehicle network based on flow information, and a DPI unit monitors an anomalous communication that is detected based on the flow information. It is thus possible to reduce misdetections in the anomaly detection system while reducing the load of the whole network. As a result, a network can be monitored while processing failure or delay is prevented even in an in-vehicle Ethernet environment, where a high-speed communication is performed, and it is thus possible to provide a safe automated-operating or advanced-driver-assistance service.

In order to solve the above problem, an anomaly detection method according to an aspect of the present disclosure, which is performed by a higher electronic control unit in an in-vehicle network, the in-vehicle network having a hierarchical structure including a higher network and a lower network, the higher network including one or more higher electronic control units including the higher electronic control unit, the lower network including one or more lower electronic control units, includes: collecting flow information including statistical information for each flow, the flow being classified based on header information of each of messages received at a predetermined observation point in the in-vehicle network; performing anomaly detection based on the flow information; and performing one of generating, adding, deleting, changing, enabling, or disabling of a Deep Packet Inspection (DPI) rule based on a result of the anomaly detection, wherein the DPI rule is used in message monitoring by the one or more lower electronic control units, and the DPI rule indicates (i) a condition for header information and payload information that are included in a message, and (ii) processing to be performed when a message satisfying the condition is received.

Accordingly, it is possible to monitor the whole network with the anomaly detection based on the flow information while reducing a processing load, without monitoring individual payload information items of messages. In addition, misdetections can be reduced with DPI rules including monitoring of the payload information that are generated based on the result of the anomaly detection. Furthermore, in an anomaly detection that first detects an anomaly using the flow information, the two-stage anomaly detection constituted of the anomaly detection based on the flow information and the monitoring using the DPI rule makes it possible to set such an anomaly detection rule that minimizes the overlooking of anomalous communication instead of allowing misdetections. As seen from the above, the present disclosure makes it possible to strike an appropriate balance between a detection accuracy and a processing amount.

By performing the anomaly detection by the higher electronic control unit based on the flow information and enabling the DPI rule generated using the result of the anomaly detection for the lower electronic control unit needing the DPI rule, the total number of messages monitored by the electronic control devices is reduced. This enables the processing load to be reduced on a per electronic-control-unit basis. Furthermore, causing the lower electronic control unit to monitor the network according to the higher electronic control unit can simplify a monitoring rule. It is thus possible to reduce computational resources allocated for monitoring the network.

For example, it is possible that the flow information includes, for each flow, information on a quantity of the messages received, and that the anomaly detection method further includes: determining, based on the information, a processing priority for each of one or more DPI rules including the DPI rule, the processing priority indicating a processing order in the message monitoring.

This enables the reduction of the number of times the lower electronic control unit checks the DPI rule against the header information items of the messages. It is thus possible to reduce computational resources consumed by the lower electronic control unit to monitor the messages.

For example, it is possible that the anomaly detection method further includes: determining, based on a detail of an anomaly detected by the anomaly detection and a total number of messages to be monitored per time unit, a time period in which the message monitoring under the DPI rule is to be enabled or a maximum number of messages to be subjected to the message monitoring under the DPI rule.

This can prevent the number of DPI rules applied to the lower electronic control unit from monotonously increasing with the passage of time. It is thus possible to reduce the processing load of the lower electronic control unit. For example, the number of packets to be monitored is specified for each DPI rule, and the DPI rule is discarded in a case where the number of packets having been monitored satisfies the specified value.

For example, it is possible that the DPI rule indicates service information or client information that is included in a message sent or received between the one or more lower electronic control units, and that in the message monitoring, when service information or client information in a message does not match the service information or the client information indicated in the DPI rule, the message is dropped.

This enables the lower electronic control unit to determine an anomalous packet and drop the anomalous packet by itself.

For example, it is possible that the anomaly detection method further includes: adding, changing, enabling, or disabling the DPI rule based on a result of the message monitoring that is outputted from a corresponding one of the one or more lower electronic control units.

It is thus possible to apply a DPI rule reflecting not only the result of the anomaly detection based on the flow information but also a result of the monitoring by the lower electronic control unit, to each lower electronic control unit. For example, in a case where a DPI rule for monitoring identifier information included in payload information of a message, such as service information or client information, is enabled, the lower electronic control unit detects unusual identifier information. In this case, the higher electronic control unit can, for example, generate or enable a DPI rule for dropping a message with the anomalous identifier information based on a result of the detection. As seen from the above, it is possible to apply a security rule based on a result of monitoring by the lower electronic control unit.

For example, it is possible that the anomaly detection method further includes: adding, changing, enabling, or disabling the DPI rule based on the result of the anomaly detection and a vehicle state, the vehicle state including at least one of gear shifting, automatic operating, automatic parking, cruise controlling, software updating, vehicle diagnosing, or Internet communication connecting.

This enables the higher electronic control unit to determine a message highly likely to incur a risk of an attack based on a current vehicle state, and to add or enable such a DPI rule for monitoring or protecting a communication including the message. In a case where a number of DPI rules exceeding a message processing capability are enabled for the lower electronic control unit, a DPI rule of high urgency can be preferentially enabled by temporarily disabling an old DPI rule.

For example, it is possible that the anomaly detection method further includes: determining the processing to be performed indicated in the DPI rule based on the vehicle state of one lower electronic control unit among the one or more lower electronic control units, the one lower electronic control unit being a source or a destination of a message determined to be anomalous in the anomaly detection.

For example, it is thus possible to prevent control of a vehicle from being seized by a malicious attacker at the time when an anomaly is detected in the anomaly detection based on the flow information. For example, in a case where the higher electronic control unit detects an anomaly from flow information on a communication with an ADAS ECU, which manages an automated operating system, the higher electronic control unit instructs the ADAS ECU to bring the vehicle to an emergency stop while securing the safety of the vehicle in a case where the vehicle is under automated operating. At that time, by enabling a DPI rule for forbidding an anomalous communication for an electronic control unit that is necessary to bring the vehicle to an emergency stop, an attack on the electronic control unit relating to the stop of the vehicle can be prevented until the vehicle comes to the stop.

For example, it is possible that the anomaly detection method further includes: selecting, from the one or more lower electronic control units, a first electronic control unit that is a source of a target message to be monitored under the DPI rule and a second electronic control unit that is a destination of the target message; selecting at least one third electronic control unit from the one or more higher electronic control units, the at least one third electronic control unit being disposed, in the hierarchical structure, between the first electronic control unit and the second electronic control unit in the hierarchical structure, the at least one third electronic control unit being an electronic control unit through which the target message passes between the first electronic control unit and the second electronic control unit; and applying the DPI rule to an electronic control unit having a smallest processing load in message processing, from among the first electronic control unit selected, the second electronic control unit selected, and the at least one third electronic control unit selected.

This prevents a number of DPI rules exceeding a message processing capability from being enabled for one of the electronic control units. It is thus possible to implement the prevention of processing failure or delay in each electronic control unit.

For example, it is possible that the anomaly detection method further includes: calculating, based on the flow information, a communication traffic of each of the first electronic control unit, the second electronic control unit, and the at least one third electronic control unit; and calculating the processing loads from the communication traffic and one or more DPI rules enabled in at least one of the one or more lower electronic control units, the one or more DPI rules each being the DPI rule.

It is thus possible to prevent processing failure or delay due to the concentration of DPI rules in one of the electronic control units by enabling the DPI rules for the plurality of electronic control units in a distributed manner.

For example, it is possible that the anomaly detection method further includes: applying the DPI rule to a third electronic control unit that is closest, in the hierarchical structure, to the first electronic control unit among the at least one third electronic control unit, when a detail of an anomaly detected by the anomaly detection indicates an anomaly that places a load on the in-vehicle network.

The higher electronic control unit close to the electronic control unit sending an anomalous message is thus made to monitor messages, making it possible to make a response with a reduced load on the network. For example, in a case where a flooding attack is detected in the anomaly detection based on the flow information, a higher electronic control unit close to a source electronic control unit monitors payload information and can drop an anomalous message immediately when an anomalous is confirmed. It is thus possible to prevent a communication that stresses the network from flowing out of a network between the source electronic control unit and the higher electronic control unit.

For example, it is possible that the anomaly detection method further includes: monitoring a message under the DPI rule by the higher electronic control unit.

This enables the higher electronic control unit, in addition to the lower electronic control unit, to monitor a message using the DPI rule, improving the accuracy of the anomaly detection.

An anomaly detection device according to another aspect of the present disclosure, which is included in each of a higher electronic control unit in an in-vehicle network, the in-vehicle network having a hierarchical structure including a higher network and a lower network, the higher network including one or more higher electronic control units including the higher electronic control unit, the lower network including one or more lower electronic control units, includes: a collector that collects flow information including statistical information for each flow, the flow being classified based on header information of each of messages received at a predetermined observation point in the in-vehicle network; an anomaly detector that performs anomaly detection based on the flow information; and a controller that performs one of generating, adding, deleting, changing, enabling, or disabling of a Deep Packet Inspection (DPI) rule based on a result of the anomaly detection, wherein the DPI rule is used in message monitoring by the one or more lower electronic control units, and the DPI rule indicates (i) a condition for header information and payload information that are included in a message, and (ii) processing to be performed when a message satisfying the condition is received.

A computer-readable recording medium according to still another aspect of the present disclosure has recorded thereon a program for causing a computer to execute the anomaly detection method.

Hereinafter, anomaly detection devices according to embodiments will be described with reference to the drawings. Note that each of the embodiments described below shows one specific example of the present disclosure. In other words, the numerical values, constituent elements, the arrangement and connection of the constituent elements, steps, the processing order of the steps as elements of processing etc., shown in the following embodiments are mere examples of the present disclosure, and are not intended to limit the present disclosure. Therefore, among the constituent elements in the following embodiments, constituent elements not recited in any one of the independent claims are optional constituent elements. Note that the respective figures are schematic diagrams and are not necessarily precise illustrations.

### Embodiment 1

Hereinafter, an anomaly detection device (anomaly detection system) for a vehicle equipped with an in-vehicle network in which a plurality of Electronic Control Units (ECUs) communicate with one another over Ethernet (in-vehicle network system) will be described.

### Overall Configuration Diagram of In-vehicle Network System

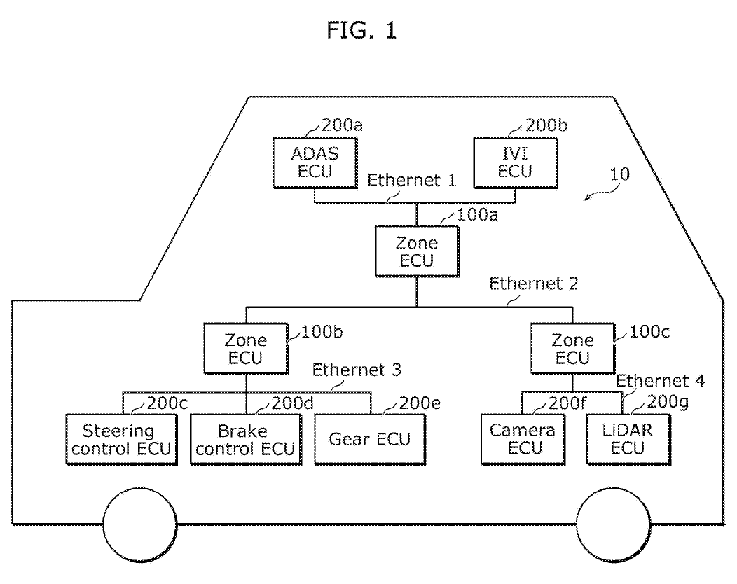

FIG. 1 is an overall configuration diagram of in-vehicle network system 10 according to Embodiment 1. As seen in FIG. 1, in-vehicle network system 10 is mounted in a vehicle. In-vehicle network system 10 includes zone ECUs 100a, 100b, and 100c, Advanced Driver-Assistance System (ADAS) ECU 200a, In-Vehicle Infotainment (IVI) ECU 200b, steering control ECU 200c, brake control ECU 200d, gear ECU 200e, camera ECU 200f, and Light Detection And Ranging (LiDAR) ECU 200g. Although not illustrated in FIG. 1, more ECUs may be included in in-vehicle network system 10.

Zone ECU 100a, ADAS ECU 200a, and IVI ECU 200b are connected together via Ethernet 1, which is a type of in-vehicle network. Zone ECU 100a, zone ECU 100b, and zone ECU 100c are connected together via Ethernet 2. Zone ECU 100b, steering control ECU 200c, brake control ECU 200d, and gear ECU 200e are connected together via Ethernet 3. Zone ECU 100c, camera ECU 200f, and LiDAR ECU 200g are connected together via Ethernet 4.

The zone ECUs are connected together via the Ethernet and communicate with one another using Scalable service-Oriented Middleware over IP (SOME/IP), which is a communication protocol for in-vehicle Ethernet. A network that does not connect different zone ECUs (Ethernet 1, 3, or 4) will be referred to as a zone. The zone ECUs are connected to their respective zones to obtain information on the ECUs and controls the ECUs.

### Configuration of Zone ECU 100a

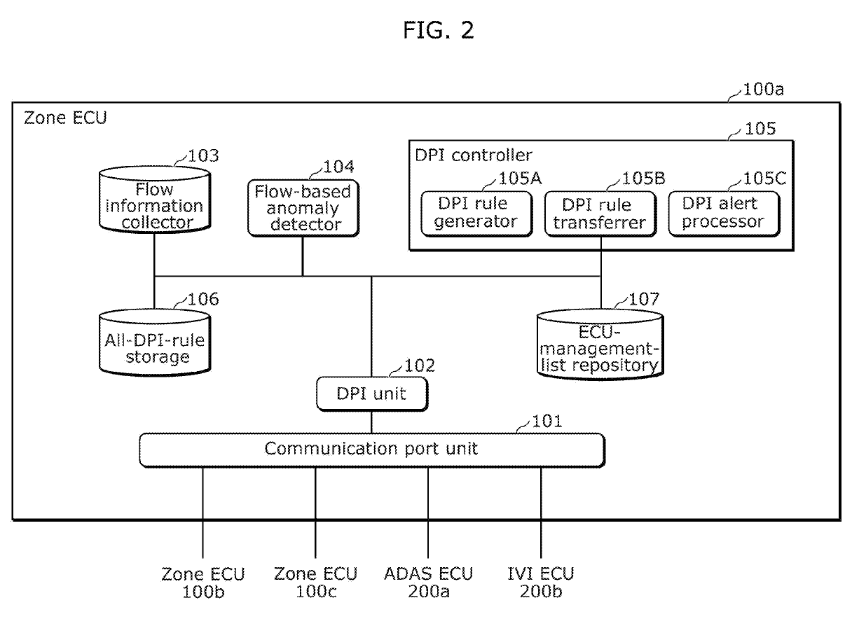

FIG. 2 is a diagram illustrating a configuration of zone ECU 100a. Note that zone ECUs 100b and 100c have substantially the same configuration as zone ECU 100a, and thus, the description thereof will be omitted.

As seen in FIG. 2, zone ECU 100a includes communication port unit 101, DPI unit 102, flow information collector 103, flow-based anomaly detector 104, DPI controller 105, all-DPI-rule storage 106, and ECU-management-list repository 107.

Communication port unit 101 is a communication interface for Ethernet. Communication port unit 101 sends and receives frames. Communication port unit 101 determines, based on the type of a received communication frame, which of the functions of the zone ECU is to process the communication frame.

DPI unit 102 monitors the payload information items of a packet based on a monitoring rule that is specified under a DPI rule. For example, in a case where communication between or among two or more ECUs, which includes broadcast communication, is performed via the zone ECU, a DPI rule for a process in which DPI unit 102 disconnects an anomalous communication or records a communication log about the anomalous communication may be applied.

Flow information collector 103 classifies packets received via Ethernet 1 or 2 based on header information and totalizes statistical information on a per classified-packet basis, thus generating flow information.

Flow-based anomaly detector 104 performs anomaly detection based on the flow information stored in flow information collector 103 and outputs a result of the detection as an anomaly alert. The anomaly alert includes not only the result of the detection but also information necessary for DPI controller 105 to generate a DPI rule.

DPI controller 105 controls a DPI rule that is to be enabled in DPI unit 102. DPI controller 105 includes DPI rule generator 105A, DPI rule transferrer 105B, and DPI alert processor 105C.

DPI rule generator 105A generates a DPI rule based on an alert outputted by flow-based anomaly detector 104 (hereinafter, an anomaly alert) or an alert outputted by the DPI unit of each ECU (hereinafter, a DPI alert). The DPI rule generated from the anomaly alert is aimed at monitoring payloads of packets mainly regarding a detail of a detected anomaly. The DPI rule generated from a DPI alert is aimed at protecting a network from an anomalous communication, such as blocking an anomalous packet.

DPI rule transferrer 105B determines an ECU to which a DPI rule generated by DPI rule generator 105A is to be applied and transfers the DPI rule to the ECU.

DPI alert processor 105C processes an alert that the DPI unit of the ECU in a zone outputs when detecting a packet falling under a checking detail of a DPI rule, to determine whether to generate an additional DPI rule.

All-DPI-rule storage 106 stores DPI rules retained in the DPI units of all the ECUs present in in-vehicle network system 10. ECU-management-list repository 107 stores a compiled list of the ECUs present in in-vehicle network system 10, service information on services provided by each ECU, and the zone ECUs managing their own zones.

### Configuration of ADAS ECU 200a

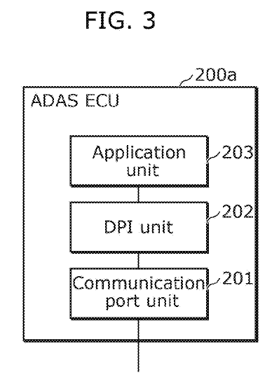

FIG. 3 is a block diagram of ADAS ECU 200a. Note that IVI ECU 200b, steering control ECU 200c, brake control ECU 200d, gear ECU 200e, camera ECU 200f, and LiDAR ECU 200g have substantially the same configuration as ADAS ECU 200a, and thus, the description thereof will be omitted.

As seen in FIG. 3, ADAS ECU 200a includes communication port unit 201, DPI unit 202, and application unit 203. Communication port unit 201 is a communication interface for Ethernet. Communication port unit 201 sends and receives frames.

DPI unit 202 monitors the payload information items of packets based on a monitoring rule that is specified under a DPI rule distributed from the zone ECU. In the case where a received packet falls under a checking detail of the DPI rule, DPI unit 202 sends an alert to the zone ECU that has distributed the DPI rule, as necessary. DPI unit 202 has substantially the same functions as DPI unit 102 of zone ECU 100a. Thus, for example, in a case where a received packet is determined to be an anomalous packet, a DPI rule for a process in which DPI unit 202 disconnects an anomalous communication or records a communication log about the anomalous communication may be applied. Application unit 203 executes an application peculiar to the ECU based on a received communication frame.

### SOME/IP Message Format

SOME/IP is a type of service-oriented communication. SOME/IP implements the service-oriented communication using four types of communication methods: Request/Response, Fire/Forget, Events, and Get/Set/Notifier in combination. SOME/IP is provided with Service Discovery (SD) as a method for establishing a session with a communication partner.

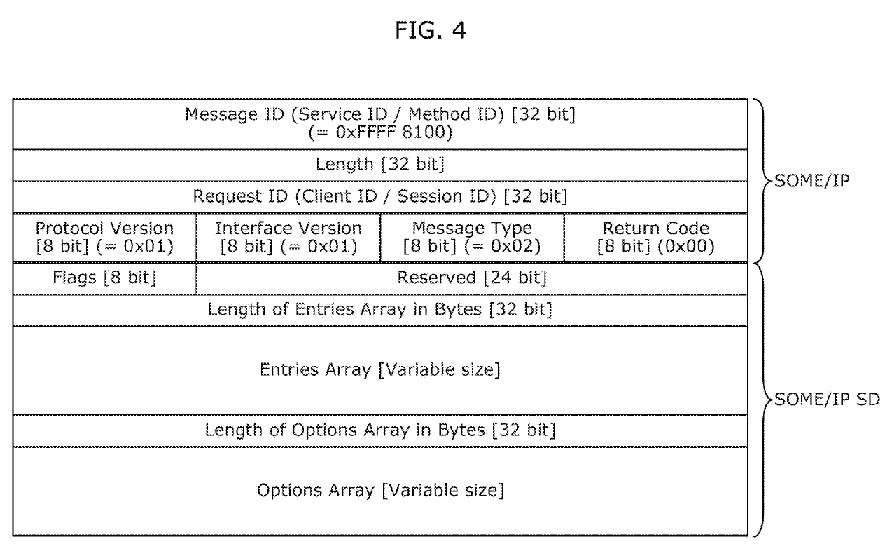

FIG. 4 is a diagram illustrating one example of a message format used in SOME/IP SD. The message format in FIG. 4 is stored in a payload portion of Ethernet for communication. In the figure, one row corresponds to 32-bit data. The format stores a SOME/IP header in its former portion and stores a SOME/IP SD payload in its latter portion. In SOME/IP SD, Message ID is 0xFFFF8100. In Length, the number of bytes of data following the Length field is stored. In Request ID, the value of Client ID and Session ID combined is stored. In SOME/IP SD, Protocol Version is set to 0x01, Interface Version is set to 0x01, Message Type is set to 0x02, and Return Code is set to 0x00.

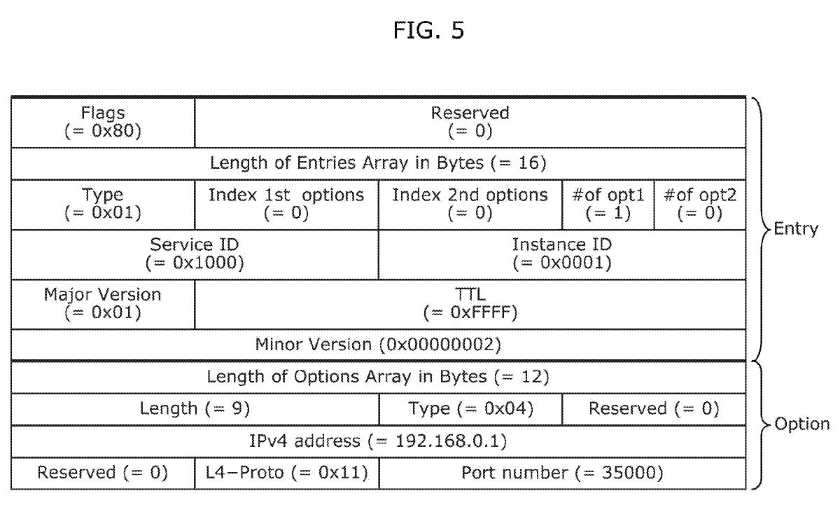

FIG. 5 is a diagram illustrating one example of a SOME/IP SD message. Flags is set to 0x80, which sets Reboot Flag. The Reserved field is set to 0. In Length of Entries Array in Bytes, the number of bytes of Entry is stored. In FIG. 5, Length of Entries Array in Bytes is set to 16 bytes.

In Type, 0x00 or 0x01 can be set; 0x00 indicates Find, and 0x01 indicates Offer. Find is used by a client ECU, which receives a service provided thereto, to request provision of a necessary service. Offer is used by a server ECU, which provides a service, to perform notification that the service can be provided. In FIG. 5, Type is 0x01, which indicates that the message is a message to perform notification of information on a service that can be provided by the server ECU itself.

Index 1st options indicates the position of the first option. In FIG. 5, Index 1st options is 0, which indicates that the position of the first option is at the start of the option field. Index 2nd options indicates the position of the second option. In FIG. 5, Index 2nd options is 0.

In #of opt1, the number of options 1 is written. In FIG. 5, 1 is stored. In #of opt2, the number of options 2 is written. In FIG. 5, 0 is stored, indicating that options 2 are not used.

Service ID is a field that stores an ID indicating the type of a service. In FIG. 5, 0x1000 is stored in Service ID. Instance ID is a field that stores an ID indicating an instance of a service. In FIG. 5, Instance ID is set to 0x0001.

Major Version is information to be used for the management of the version of a service. In FIG. 5, 0x01 is stored in Major Version.

TTL is a field for setting a valid period (seconds) of a service. In FIG. 5, TTL is set to 0xFFFF. TTL being 0xFFFF indicates that the service is valid until the next start of the ECU.

Minor Version is information to be used for the management of the version of a service. In FIG. 5, Minor Version is set to 0x00000002.

In Length of Options Array in Bytes, which is included in the Option field, the byte length of the Option field is stored. In FIG. 5, Length of Options Array in Bytes indicates that the byte length of the Option field is 12 bytes.

The value of Length is set based on the type of the option. In FIG. 5, which illustrates an example of communication using IPv4, Length is set to 9, Type is set to 0x04, and Reserved is set to 0x00. The IPv4 address the IP address of a server. In FIG. 5, the IPv4 address is set to 192.168.0.1.

In the Reserved field, 0 is stored. In L4-Proto, 0x11 is stored, indicating the use of the User Datagram Protocol (UDP). At the end, the port number is stored. In FIG. 5, the port number indicates that the port 35000 is used.

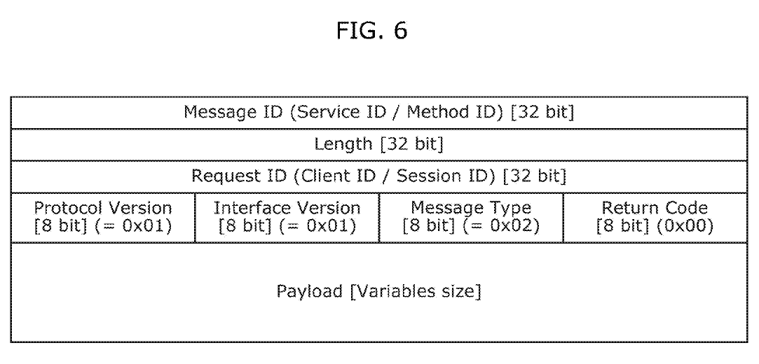

FIG. 6 is a diagram illustrating one example of a message format used in SOME/IP. The SOME/IP header part, which excludes Payload, is the same as in FIG. 4.

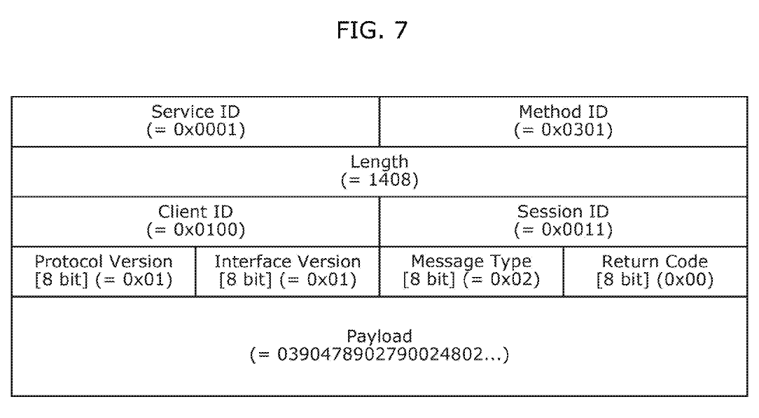

FIG. 7 is a diagram illustrating one example of a SOME/IP message. Service ID is a field that stores an ID indicating the type of a service. In FIG. 7, 0x0001 is stored in Service ID.

Method ID is a field that stores an ID indicating the type of Method, which is a function on a server to be called from a client. In FIG. 7 0x0301 is stored in Method ID.

In Length, a message length from Client ID to Payload. In FIG. 7, Length is set to 1408 bytes. Client ID is an identifier for identifying a client that is a caller in an ECU. In FIG. 7, Client ID is set to 0x01000.

Session ID is an identifier for discriminating messages dispatched by the same sender. In FIG. 7, Session ID is set to 0x0011. Protocol Version shows the protocol version of SOME/IP. In FIG. 7, Protocol Version is set to 0x01.

Interface Version shows the major version of a service I/F. In FIG. 7, Interface Version is set to 0x01. Message Type shows the message type of SOME/IP. In FIG. 7, Message Type is set to 0x02, which indicates that the message type is Notification.

Return Code shows a return value that indicates whether a request has been processed normally. In FIG. 7, Return Code is set to 0x00. In Payload, information that a sender intends to send is written.

### One Example of Flow Information Items Collected by Zone ECU

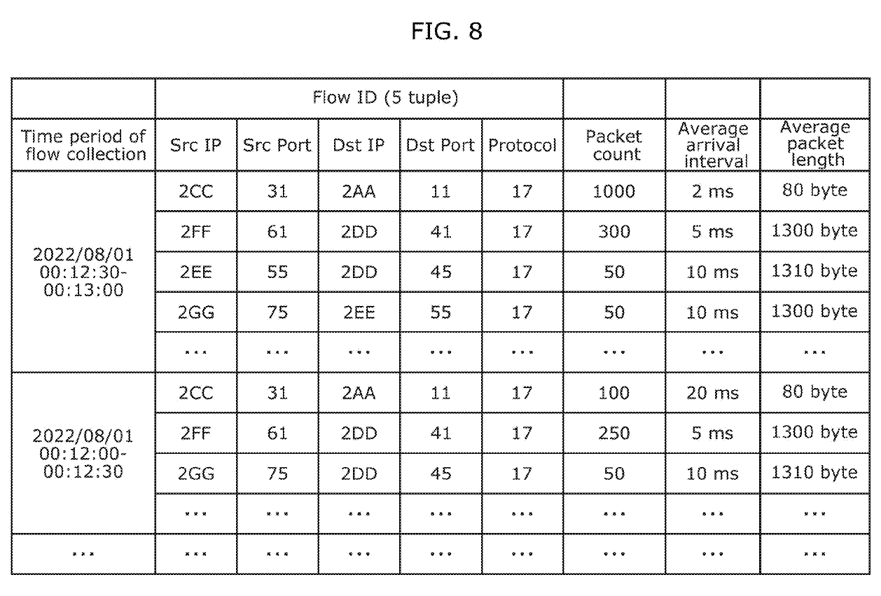

FIG. 8 is a table showing one example of flow information items collected by flow information collector 103 of a zone ECU. The flow information items are generated by calculating statistical information from header information items or the like of packets every given time period. In FIG. 8, the flow information items are calculated at 30-second intervals. In each flow information item, the combination of the source IP address (Src IP), the source port number (Src Port), the destination IP address (Dst IP), the destination port number (Dst Port), and the protocol number (Protocol) of packets is assigned as a flow ID, which is identification information. For an identical flow ID, the statistical information is totalized. In FIG. 8, the number of packets communicated, the average arrival interval of the packets, and an average packet length are totalized for each flow ID.

### One Example of All-DPI-rule List

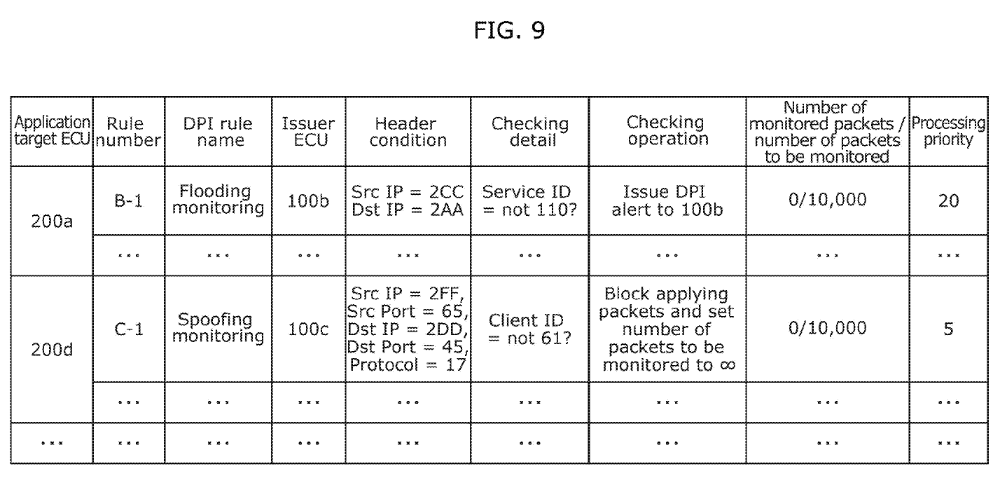

FIG. 9 is a table showing one example of a list in which all DPI rules applied to the ECUs on the in-vehicle network and saved in all-DPI-rule storage 106 are written (hereinafter, an all-DPI-rule list).

To each DPI rule, an application target ECU, a rule number, a DPI rule name, an issuer ECU, a header condition, a checking detail, a checking operation, the number of packets to be monitored, the number of monitored packets, and a processing priority.

To the application target ECU, an ECU including the DPI unit that is to actually execute the generated DPI rule is set. In the all-DPI-rule list in FIG. 9, DPI rules are written on an application-target-ECU basis. The rule number is given to the DPI rule for DPI rule management.

The DPI rule name is determined based on the role of the DPI rule. For example, for a DPI rule generated based on an anomaly alert, the DPI rule name is determined based on a detail of a detected anomaly, such as Flooding monitoring, Spoofing monitoring, or Man-in-the-middle-attack monitoring. For a DPI rule generated based on a DPI alert, the DPI rule name of anomalous communication is given.

To the issuer ECU, a zone ECU that has generated the DPI rule and transferred the generated DPI rule to the application target ECU is set. The issuer ECU is determined according to an ECU management list.

The header condition indicates all or some of the source IP address, the source port number, the destination IP address, the destination port number, and the protocol number of each of packets to be monitored. The payloads of packets that satisfy all of the items written in this header condition are to be monitored and examined on the checking detail.

The checking detail indicates a detail of checking that is to be performed in monitoring the payload of packets satisfying the header condition. For example, in the case of a SOME/IP communication that may be a potential flooding attack, it is assumed that an attacking ECU sends a large number of packets with one type of Service ID. Thus, a source ECU of the anomalous packets is determined as the attacking ECU, and whether the number of types of Service ID of the packets sent from the source ECU is only one is checked. In the case of a SOME/IP communication that may be a potential spoofing attack, whether the communication is performed with a proper Client ID is checked.

The checking operation indicates an operation for a case where a monitored packet satisfies the checking detail. For example, in the case where a packet falls under the checking detail of Flooding monitoring shown in FIG. 9, the source ECU of a communication being monitored is not an ECU that performs a communication using only one type of Service ID. That is, the source ECU is determined to be a normal ECU, and a notification of the determination is provided to the zone ECU, which is an issuer of the DPI rule. In the case where a packet falls under the checking detail of Spoofing monitoring shown in FIG. 9, it is determined that a communication is performed with a spoofed IP address and a spoofed port number, the packet is blocked, and the number of packets to be monitored is set to an unlimited number.

The number of packets to be monitored indicates the upper limit value of the number of packets to be monitored under the DPI rule. The number of monitored packets indicates the number of packets that have already been monitored by the DPI unit under the DPI rule. In the case where the number of monitored packets under the DPI rule reaches a specified number of packets to be monitored, DPI units 102 and 202 discard the DPI rule. The zone ECU can also grasp, from the flow information, the number of packets communicated by each ECU for each flow ID and calculates the numbers of monitored packets under all of the DPI rules in all-DPI-rule storage 106.

The processing priority is a parameter for determining, in the case where two or more DPI rules are applied to DPI unit 102 or 202, the order of checking the header of a packet against a header condition included in each of the DPI rules. The processing priority is calculated based on the flow information and determined according to the proportion of packets monitored under the DPI rule to all packets communicated by the ECU. DPI units 102 and 202 check the header of a received packet against a header condition included in each of the DPI rules in descending order of the processing priorities of the DPI rules. DPI units 102 and 202 of the ECUs save DPI rules in descending order of processing priorities.

### ECU Management List

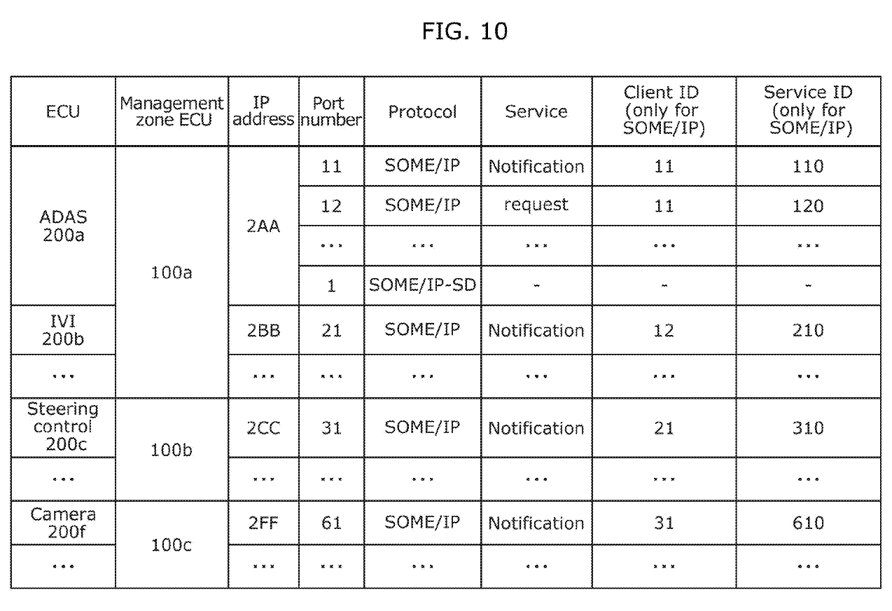

FIG. 10 is a table showing an ECU management list saved in ECU-management-list repository 107 of each zone ECU. In the ECU management list, all of the ECUs present in the in-vehicle network are written in the form of a list. Each of the ECUs is assigned a zone ECU present in the same zone, as a manager (a management zone ECU). The zone ECU causes DPI rule transferrer 105B to transfer DPI rules generated by DPI rule generator 105A only in the case where the distribution destination of the DPI rules is an ECU managed by the zone ECU itself.

In the ECU management list, an IP address and port numbers used by each ECU are written. For each of the port numbers, a protocol to be used and a detail of a service are written. In the case where the protocol is SOME/IP, a client ID and a service ID are further written.

By checking the ECU management list, the zone ECU can check service information on a SOME/IP communication, such as a service ID or a client ID, from an IP address and a port number in the flow information without checking payload information.

### Processing Sequence

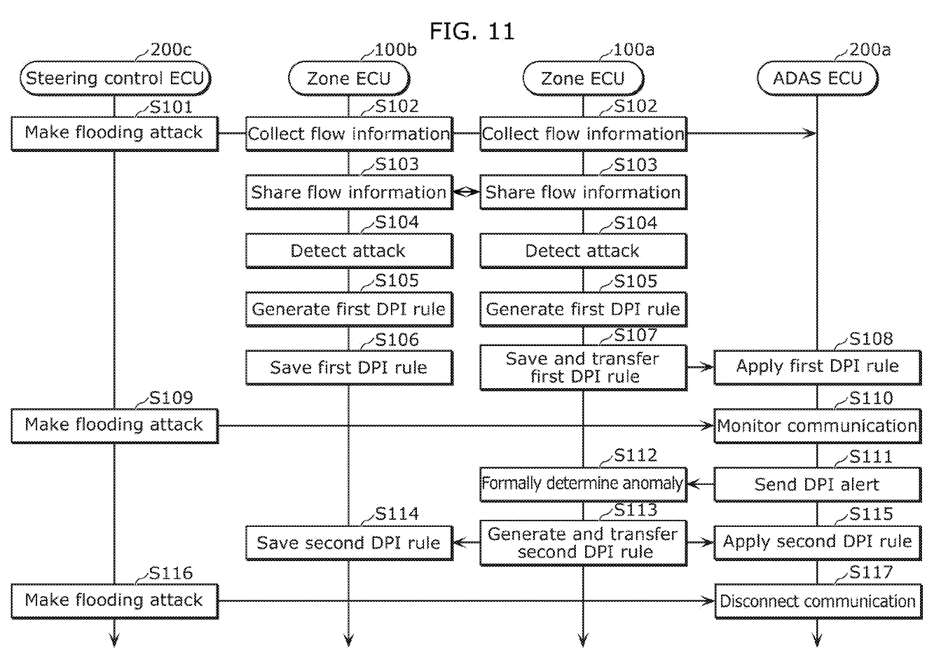

FIG. 11 is a processing sequence diagram for a case of the occurrence of an attack from steering control ECU 200c to ADAS ECU 200a according to Embodiment 1. In FIG. 11, zone ECUs 100a and 100b each collect flow information with flow information collector 103, perform anomaly detection with flow-based anomaly detector 104, and generate a DPI rule with DPI rule generator 105A based on a result of the anomaly detection. DPI unit 202 of ADAS ECU 200a applies a generated DPI rule to perform security response based on a result of monitoring by DPI unit 202.

Steering control ECU 200c makes a flooding attack on ADAS ECU 200a (S101). Zone ECUs 100a and 100b, which are present on a communication route between steering control ECU 200c and ADAS ECU 200a, mirror packets and receive the packets, thus collecting the flow information (S102).

Zone ECUs 100a, 100b, and 100c share the flow information collected by zone ECUs 100a, 100b, and 100c (S103). Note that the processing by zone ECU 100c is not illustrated in FIG. 11.

Based on the shared flow information, zone ECUs 100a, 100b, and 100c perform flow-base anomaly detection, thus detecting that steering control ECU 200c is attacking ADAS ECU 200a (S104). Based on a result of the flow-base anomaly detection, zone ECUs 100a, 100b, and 100c each generate a first DPI rule for monitoring the communication (S105).

According to the ECU management list, an application target of the generated first DPI rule is not a management target for zone ECU 100b, and thus zone ECU 100b saves the first DPI rule in its all-DPI-rule storage 106 (S106).

According to the ECU management list, the application target of the generated first DPI rule is a management target for zone ECU 100a, and thus zone ECU 100a saves the first DPI rule in its all-DPI-rule storage 106 and transfers the first DPI rule to ADAS ECU 200a (S107).

ADAS ECU 200a receives the first DPI rule from zone ECU 100a and applies the received first DPI rule to its DPI unit 202 (S108). Steering control ECU 200c continues making the flooding attack on ADAS ECU 200a (S109).

Using the applied first DPI rule, ADAS ECU 200a monitors the communication with steering control ECU 200c (S110). ADAS ECU 200a generates a DPI alert based on a result of the monitoring by DPI unit 202 and sends the generated DPI alert to zone ECU 100a (S111).

Based on the DPI alert from ADAS ECU 200a, zone ECU 100a formally determines that the communication with steering control ECU 200c is an anomalous communication (S112). Zone ECU 100a generates a second DPI rule for disconnecting the anomalous communication from steering control ECU 200c and transfers the generated second DPI rule to ADAS ECU 200a and the other zone ECUs: zone ECUs 100b and 100c (S113).

Zone ECU 100b saves the second DPI rule, which has newly been generated by zone ECU 100a, in all-DPI-rule storage 106 (S114). ADAS ECU 200a applies the second DPI rule transferred from zone ECU 100a (S115).

Steering control ECU 200c continues making the flooding attack on ADAS ECU 200a (S116). ADAS ECU 200a disconnects the anomalous communication from steering control ECU 200c according to the second DPI rule (S117).

### Flowchart of Processing in Zone ECU

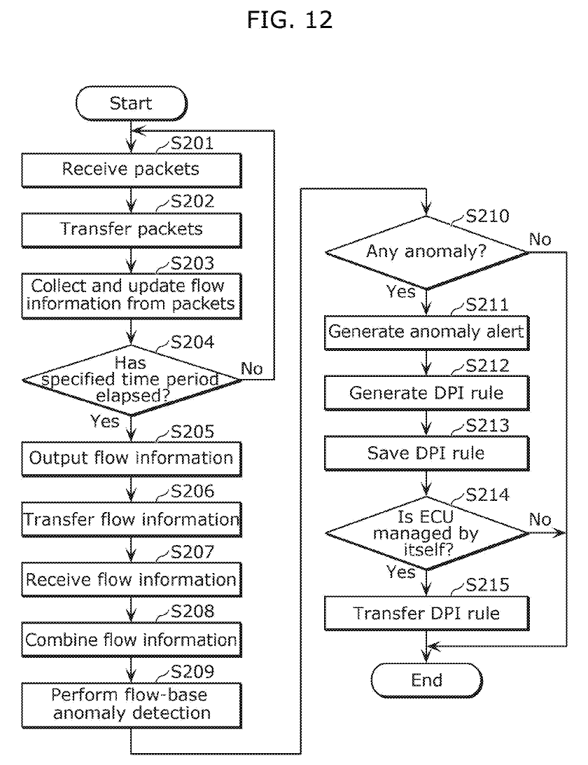

FIG. 12 is a flowchart of the whole processing from when a zone ECU receives a packet to generate a DPI rule until when the DPI rule is applied to an appropriate ECU. Communication port unit 101 receives packets that pass through itself (S201).

Mirroring the packets, communication port unit 101 transfers the packets referring to destination IP addresses of the packets (S202). Flow information collector 103 extracts header information from the mirrored packets to update the flow information (S203).

Flow information collector 103 determines whether a specified time period of collecting the flow information has elapsed (S204). In a case where the specified time period has elapsed (Yes in S204), flow information collector 103 outputs the flow information (S205). In a case where the specified time period has not elapsed (No in S204), the zone ECU returns to the first step S201.

Communication port unit 101 transfers the outputted flow information to other zone ECUs (S206). Communication port unit 101 also receives flow information transferred from the other zone ECUs (S207). Flow information collector 103 then combines the flow information outputted by itself and the flow information transferred from the other zone ECUs (S208).

Flow-based anomaly detector 104 performs the flow-base anomaly detection based on the combined flow information (S209) and determines whether any anomaly has occurred (S210). In a case where any anomaly has occurred (Yes in S210), flow-based anomaly detector 104 generates an anomaly alert in which a detail of the anomaly is written (S211). In a case where no anomaly has occurred (No in S210), the zone ECU completes the processing.

From the generated anomaly alert, DPI rule generator 105A generates a DPI rule (S212). DPI rule generator 105A saves the generated DPI rule in all-DPI-rule storage 106 (S213).

DPI rule transferrer 105B determines whether an application target ECU of the generated DPI rule is an ECU managed by the zone ECU based on the ECU management list (S214). In a case where the application target ECU is an ECU managed by the zone ECU (Yes in S214), DPI rule transferrer 105B transfers the DPI rule to the application target ECU (S215), and the zone ECU completes the processing. In a case where the application target ECU is not an ECU managed by the zone ECU (No in S214), the zone ECU completes the processing.

### Flowchart of Reception Processing by Communication Port Unit of Zone ECU

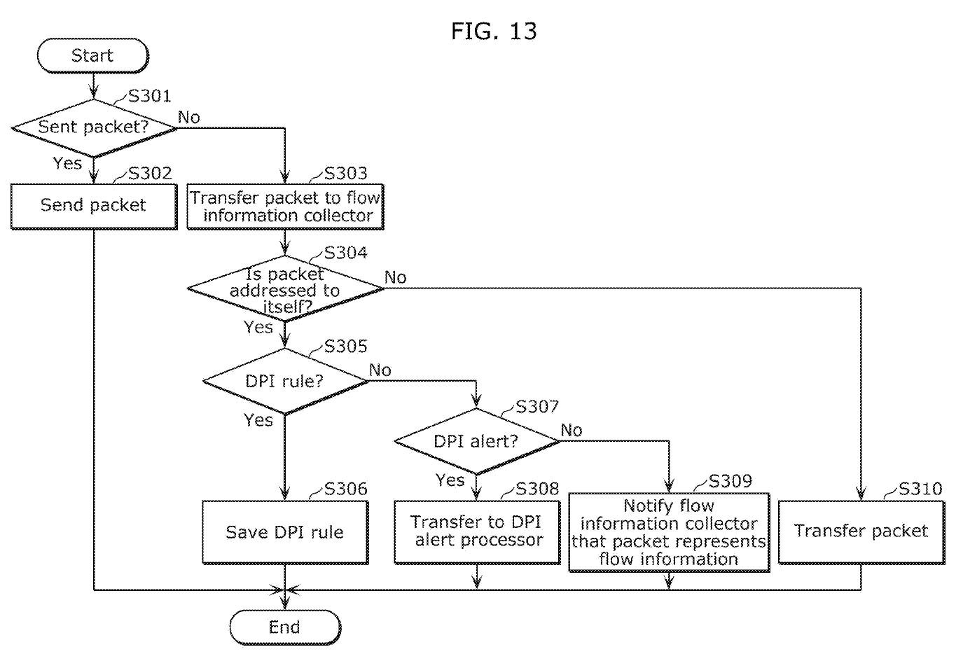

FIG. 13 is a flowchart of reception processing by communication port unit 101 of a zone ECU. Communication port unit 101 transfers information on a received packet to an appropriate function of the zone ECU in accordance with the type of the packet.

Communication port unit 101 determines whether a packet being processed by communication port unit 101 is a sent packet of which the source is the zone ECU (S301). In a case where the packet is a sent packet (Yes in S301), communication port unit 101 sends the packet to an ECU with a destination IP address (S302).

In a case where the packet is not a sent packet (No in S301), communication port unit 101 mirrors the received packet and transfers the mirrored packet to flow information collector 103 (S303).

Communication port unit 101 determines whether the received packet is a packet addressed to the zone ECU (S304). In a case where the packet is a packet addressed to the zone ECU (Yes in S304), communication port unit 101 determines whether the packet represents a DPI rule transferred from another zone ECU (S305). In a case where the packet represents a DPI rule (Yes in S305), communication port unit 101 saves the transferred DPI rule in all-DPI-rule storage 106 (S306), and the zone ECU completes the processing.

In a case where the packet does not represent a DPI rule (No in S305), communication port unit 101 determines whether the packet represents a DPI alert transferred from another ECU (S307). In a case where the packet represents a DPI alert (Yes in S307), communication port unit 101 transfers the packet to DPI alert processor 105C (S308), and the zone ECU completes the processing.

In a case where the packet does not represent a DPI alert (No in S307), the received packet represents flow information to be shared with another zone ECU. Communication port unit 101 thus notifies flow information collector 103 that the packet represents flow information having been generated by the other ECU (S309), and the zone ECU completes the processing. Flow information collector 103 updates its flow information from the header information of the packet, integrating flow information on another zone written in the payload information of the packet with the flow information collected by flow information collector 103.

In a case where the packet is not a packet addressed to the zone ECU (No in S304), communication port unit 101 transfers the packet to an ECU with a destination IP address (S310), and the zone ECU completes the processing.

### One Example of Execution of Flow-base Anomaly Detection

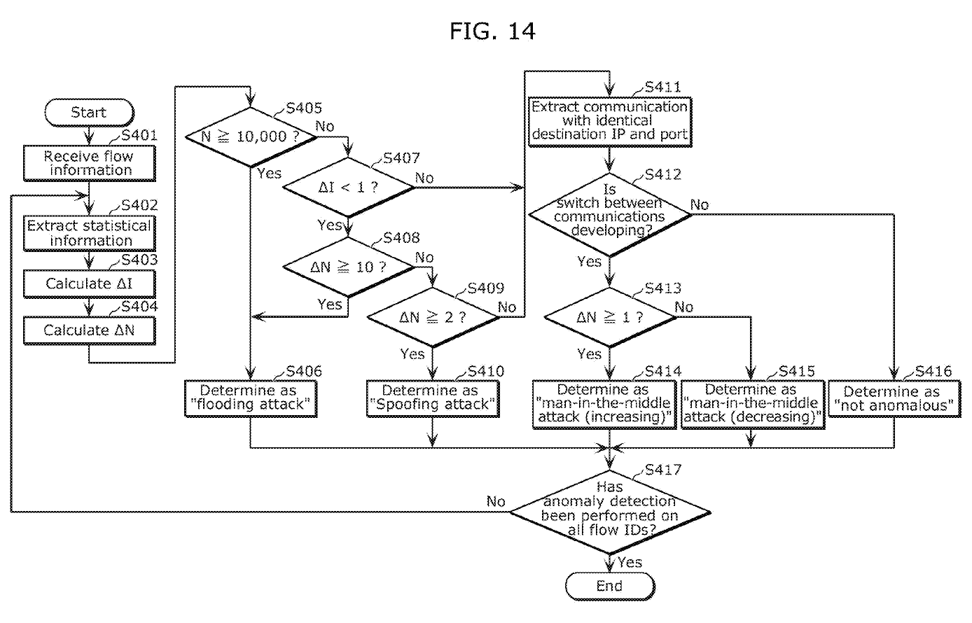

FIG. 14 is a flowchart illustrating one example of processing by flow-based anomaly detector 104. Flow-based anomaly detector 104 first receives flow information that is outputted every given time period (S401).

Flow-based anomaly detector 104 selects one flow ID included in the received flow information and extracts statistical information (e.g., packet count N, average arrival interval I) for the selected flow ID (S402). Note that the processes of steps S403 to S416 are executed for the selected flow ID. That is, the processes of steps S402 to S416 are repeatedly executed for each flow ID included in the flow information. Furthermore, the series of processes is repeatedly executed every time flow information is received.

Flow-based anomaly detector 104 calculates a to-previous-time ratio ΔI, which is the ratio between average arrival interval I included in the flow information received this time and an average arrival interval I included in flow information outputted the previous time (S403). For example, ΔI is calculated by dividing average arrival interval I of this time by average arrival interval I of the previous time.

Flow-based anomaly detector 104 calculates a to-previous-time ratio ΔN, which is the ratio between a packet count N being the number of packets included in the flow information received this time and a packet count N being the number of packets included in the flow information outputted the previous time (S404). For example, ΔN is calculated by dividing packet count N of this time by packet count N of the previous time.

Flow-based anomaly detector 104 determines whether packet count N is greater than or equal to 10000 (S405). In a case where packet count N is greater than or equal to 10000 (Yes in S405), flow-based anomaly detector 104 determines that the communication having the selected flow ID is under "flooding attack" (S406). That is, flow-based anomaly detector 104 determines that the communication is under "flooding attack" in a case where packet count N is greater than or equal to a predetermined threshold.

In a case where packet count N is less than 10000 (No in S405), flow-based anomaly detector 104 determines whether to-previous-time ratio ΔI between the average arrival intervals is less than 1 (S407). In a case where to-previous-time ratio ΔI between the average arrival intervals is less than 1 (Yes in S407), flow-based anomaly detector 104 further determines whether to-previous-time ratio ΔN between the packet counts is greater than or equal to 10 (S408). In a case where to-previous-time ratio ΔN between the packet counts is greater than or equal to 10 (Yes in S408), flow-based anomaly detector 104 determines that the communication having the selected flow ID is under "flooding attack" (S406). That is, flow-based anomaly detector 104 determines that the communication is under "flooding attack" in a case where average arrival interval I is decreasing, and where packet count N is increasing (ΔN is greater than or equal to a first threshold, which is greater than 1).

In a case where to-previous-time ratio ΔN between the packet counts is less than 10 (No in S408), flow-based anomaly detector 104 determines whether to-previous-time ratio ΔN between the packet counts is greater than or equal to 2 (S409). In a case where to-previous-time ratio ΔN between the packet counts is greater than or equal to 2 (Yes in S409), flow-based anomaly detector 104 determines that the communication having the selected flow ID is under "spoofing attack" (S410). That is, flow-based anomaly detector 104 determines that the communication is under "flooding attack" in a case where average arrival interval I is decreasing, and where packet count N is increasing (ΔN is greater than or equal to a second threshold, which is greater than 1 and less than the first threshold).

In a case where to-previous-time ratio ΔI between the average arrival intervals is greater than or equal to 1 or where to-previous-time ratio ΔN between the packet counts is less than 2 (No in S407 or No in S409), flow-based anomaly detector 104 extracts a communication having another flow ID in which a destination IP address and a destination port number are identical to those in the selected flow ID (S411).

Flow-based anomaly detector 104 determines whether a switch from one communication to another is developing (S412). Specifically, flow-based anomaly detector 104 determines that the switch from one communication to another is developing in a case where one of packet count N of the packets with the selected flow ID and packet count N of packets with the other flow ID extracted is increasing, and where the other is decreasing.

In a case where the switch from one communication to another is developing (Yes in S412), flow-based anomaly detector 104 further determines whether to-previous-time ratio ΔN between the packet counts is greater than or equal to 1 (S413). In a case where to-previous-time ratio ΔN between the packet counts is greater than or equal to 1 (Yes in S413), flow-based anomaly detector 104 determines that the communication having the selected flow ID is being increased by a man-in-the-middle attack and determines that the communication is under "man-in-the-middle attack (increasing)" (S414). That is, flow-based anomaly detector 104 determines that the communication is under "man-in-the-middle attack (increasing)" in a case where the switch from one communication to another is developing, and where packet count N is increasing.

In a case where to-previous-time ratio ΔN between the packet counts is less than 1 (No in S413), flow-based anomaly detector 104 determines that the communication having the selected flow ID is being decreased by a man-in-the-middle attack and determines that the communication is under "man-in-the-middle attack (decreasing)" (S415). That is, flow-based anomaly detector 104 determines that the communication is under "man-in-the-middle attack (decreasing)" in a case where the switch from one communication to another is developing, and where packet count N is decreasing.

In a case where no switch from one communicate to another is developing (No in S412), flow-based anomaly detector 104 determines that the communication falls under none of the determinations of attack and determines that the communication having the selected flow ID is "not anomalous" (S416).

After determining the communication having the selected flow ID as any one of "flooding attack", "spoofing attack", "man-in-the-middle attack (increasing) ", "man-in-the-middle attack (decreasing) ", "not anomalous", flow-based anomaly detector 104 determines whether the processing for the anomaly detection has been performed on all flow IDs (S417). In a case where the processing has been completed on all flow IDs (Yes in S417), the zone ECU completes the processing. In a case where the processing has not been completed on all flow IDs (No in S417), flow-based anomaly detector 104 returns to step S402 and perform the same processing on one or more flow IDs that have not been subjected to the processing for the anomaly detection.

In the processing for the anomaly detection in FIG. 14, the certain specific thresholds are used for the determination of an anomaly. In actuality, the thresholds are changed in accordance with an assumed communication environment. In FIG. 14, the anomaly detection is performed with only the parameters called packet count and average arrival interval. However, another parameter can be used to improve the accuracy of the detection. In addition, the anomaly detection can detect an attack other than the flooding attack, the spoofing attack, and the man-in-the-middle attack.

### One Example of Generated Anomaly Alert

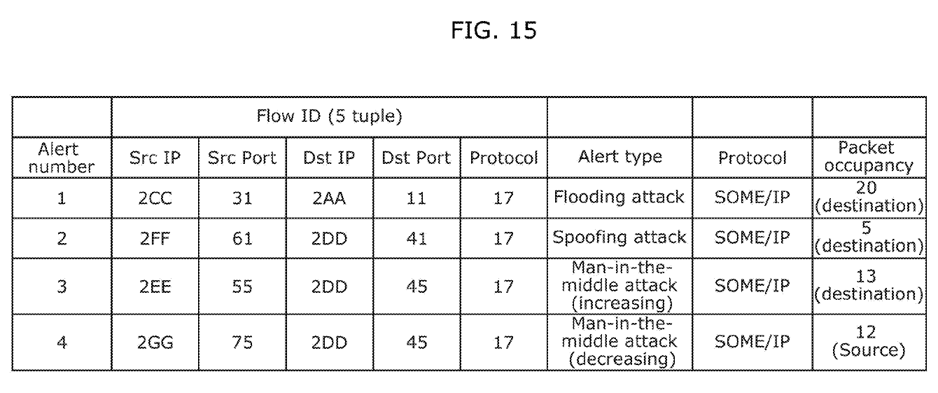

FIG. 15 is a table showing one example of an anomaly alert that is generated based on a result of the flow-base anomaly detection. The generated anomaly alert includes information necessary for DPI rule generator 105A to generate a DPI rule. The anomaly alert includes an alert number, the flow ID of a communication determined to be anomalous, an alert type, a protocol, and a packet occupancy at a destination ECU.

An alert number is issued for a flow ID of each communication in which an anomaly is detected. Note that in a case where two or more communications are considered to constitute an attack such as a man-in-the-middle attack, the two or more communications are assigned the same alert number. The flow ID indicates the header information of a communication packet. The alert is generated due to the determination that the communication identified with the flow ID is anomalous.

The alert type indicates a result of the determination in the flow-base anomaly detection. The man-in-the-middle attack is detected from the interrelation between two communications: a communication of an increasing number of packets and a communication of a decreasing number of packets. Thus, an anomaly alert is generated for two respective flow IDs. The protocol indicates the protocol of the communication having the flow ID. The protocol is used to determine whether the communication is an encrypted communication.

The packet occupancy is a parameter used to set the processing priority of a DPI rule. The packet occupancy indicates the proportion of packets with the flow ID to all packets communicated by the ECU with the destination IP address assigned to the flow ID. Note that, only in a case where the alert type is "man-in-the-middle attack (decreasing)", the packet occupancy is calculated with reference to source IP address assigned to the flow ID, rather than the destination IP address assigned to the flow ID.

### Flowchart of Generating DPI Rule

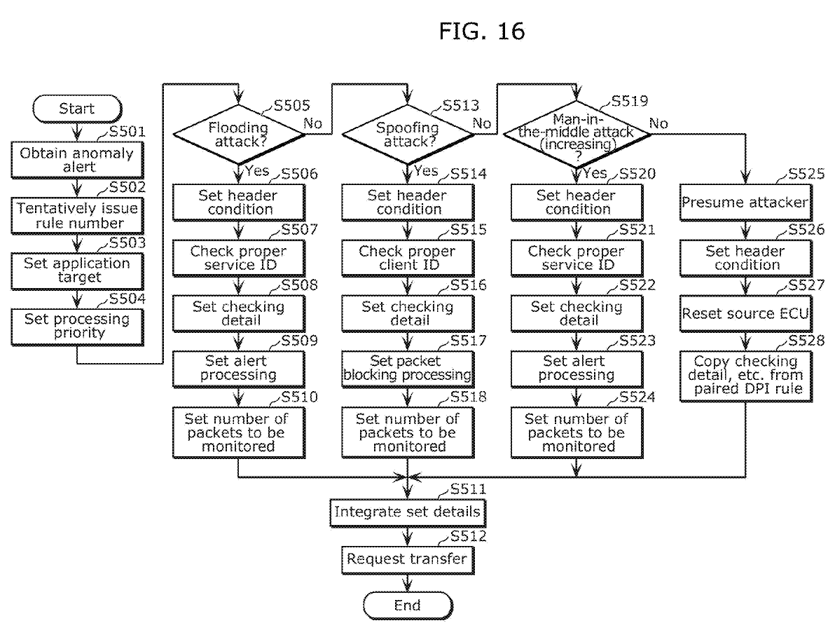

FIG. 16 is a flowchart of DPI rule generation processing. DPI rule generator 105A obtains an anomaly alert generated by flow-based anomaly detector 104 (S501).

DPI rule generator 105A tentatively issues a rule number of a DPI rule (S502). For example, in a case of a man-in-the-middle attack or the like, in which there are a plurality of anomaly alerts with the same alert number, DPI rule generator 105A tentatively issues the same rule number. The rule number is formally reissued by DPI rule transferrer 105B.

DPI rule generator 105A sets an application target of the DPI rule is set to an ECU with a destination IP address assigned to a flow ID included in the anomaly alert (S503). From the anomaly alert, DPI rule generator 105A extracts a packet occupancy at the set application target ECU and sets the extracted packet occupancy as the value of a processing priority included in the DPI rule (S504).

DPI rule generator 105A determines whether an alert type included in the anomaly alert is "flooding attack" (S505). In a case where the alert type is "flooding attack" (Yes in S505), DPI rule generator 105A sets a source IP address and the destination IP address assigned to the flow ID included in the anomaly alert as a header condition included in the DPI rule (S506).

DPI rule generator 105A then refers to the ECU management list to check a proper service ID from the flow ID (S507) and sets a checking detail included in the DPI rule using the checked service ID (S508). DPI rule generator 105A sets, as a checking operation included in the DPI rule, processing for issuing an alert to a zone ECU that has been issued the DPI rule (S509). DPI rule generator 105A sets the number of packets to be monitored included in the DPI rule to a value necessary to monitor the flooding attack (a value associated with the monitoring of the flooding attack) (S510). DPI rule generator 105A then integrates the details that have been set thus far into one DPI rule (S511).

DPI rule generator 105A requests DPI rule transferrer 105B to transfer the generated DPI rule to the set application target ECU (S512) and completes the DPI rule generation processing.

In a case where the alert type is not "flooding attack" (No in S505), DPI rule generator 105A determines whether the alert type included in the anomaly alert is "spoofing attack" (S513). In a case where the alert type is "spoofing attack" (Yes in S513), DPI rule generator 105A sets the flow ID included in the anomaly alert as the header condition included in the DPI rule (S514). DPI rule generator 105A then refers to the ECU management list to check a proper client ID from the flow ID (S515) and sets a checking detail included in the DPI rule using the checked client ID (S516).

DPI rule generator 105A sets, as a checking operation included in the DPI rule, a process of blocking packets with the flow ID and resetting the number of packets to be monitored by the application target ECU to an unlimited number (∞) (S517). DPI rule generator 105A sets the number of packets to be monitored included in the DPI rule to a value necessary to monitor the spoofing attack (a value associated with the monitoring of the spoofing attack) (S518). DPI rule generator 105A then integrates the details that have been set thus far into one DPI rule (S511), makes a request for transferring the DPI rule (S512), and completes the DPI rule generation processing.

In a case where the alert type is not "spoofing attack" (No in S513), DPI rule generator 105A determines whether the alert type included in the anomaly alert is "man-in-the-middle attack (increasing)" (S519). In a case where the alert type is "man-in-the-middle attack (increasing)" (Yes in S519), DPI rule generator 105A sets a source IP address and the destination IP address assigned to the flow ID included in the anomaly alert as a header condition included in the DPI rule (S520).

DPI rule generator 105A then refers to the ECU management list to check a proper service ID from the flow ID (S521) and sets a checking detail included in the DPI rule using the checked service ID (S522). DPI rule generator 105A sets, to a zone ECU that has issued the DPI rule, a process of issuing an alert as a checking operation included in the DPI rule (S523). DPI rule generator 105A sets the number of packets to be monitored included in the DPI rule to a value necessary to monitor the man-in-the-middle attack (a value associated with the monitoring of the man-in-the-middle attack) (S524). DPI rule generator 105A then integrates the details that have been set thus far into one DPI rule (S511), makes a request for transferring the DPI rule (S512), and completes the DPI rule generation processing.

In a case where the alert type is not "man-in-the-middle attack (increasing)" (No in S519), DPI rule generator 105A determines whether the alert type included in the anomaly alert is "man-in-the-middle attack (decreasing)". DPI rule generator 105A presumes that an ECU with a source IP address assigned to a flow ID included in an anomaly alert that has the same alert number and of which the alert type is "man-in-the-middle attack (increasing)" is an attacking ECU (S525). DPI rule generator 105A extracts a source ECU from the flow ID included in the anomaly alert of which the alert type is "man-in-the-middle attack (decreasing)" and a tuple including the IP addresses of the source ECU and the presumed attacking ECU (the attacking ECU is located on a destination side) as a header condition included in the DPI rule (S526).

DPI rule generator 105A resets the application target ECU included in the DPI rule to the ECU with the source IP address assigned to the flow ID (S527). DPI rule generator 105A sets a checking detail, a checking operation, and the number of packets to be monitored included in the DPI rule such that they become the same as those of a paired DPI rule, that is, a DPI rule that has the same alert number and has been generated from an anomaly alert of which the alert type is "man-in-the-middle attack (increasing)" (S528). DPI rule generator 105A then integrates the details that have been set thus far into one DPI rule (S511), makes a request for transferring the DPI rule (S512), and completes the DPI rule generation processing.

### Flowchart of Transfer of DPI Rule

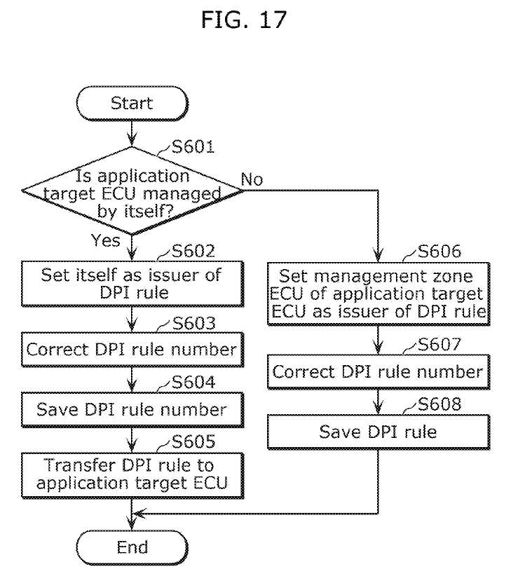

FIG. 17 is a flowchart of transfer of a DPI rule. DPI rule transferrer 105B determines whether an application target ECU included in a DPI rule generated with reference to the ECU management list is an ECU managed by the zone ECU of DPI rule transferrer 105B (S601).

In a case where the application target ECU is the ECU managed by the zone ECU (Yes in S601), DPI rule transferrer 105B sets an issuer ECU included in the DPI rule to the zone ECU (S602) corrects a DPI rule number so that the zone ECU being the issuer can be identified (S603), and saves the DPI rule in all-DPI-rule storage 106 (S604). DPI rule transferrer 105B then transfer the DPI rule to the application target ECU (S605) and completes the processing for the transfer of the DPI rule.

In a case where the application target ECU is not an ECU managed by the zone ECU (No in S601), DPI rule transferrer 105B refers to the ECU management list and sets the issuer ECU included in the DPI rule to a management zone ECU that manages the application target ECU (S606). DPI rule transferrer 105B corrects the DPI rule number so that the zone ECU being the issuer can be identified (S607), saves the DPI rule in all-DPI-rule storage 106 (S608), and completes the processing for the transfer of the DPI rule.

### One Example of Generated DPI Rule

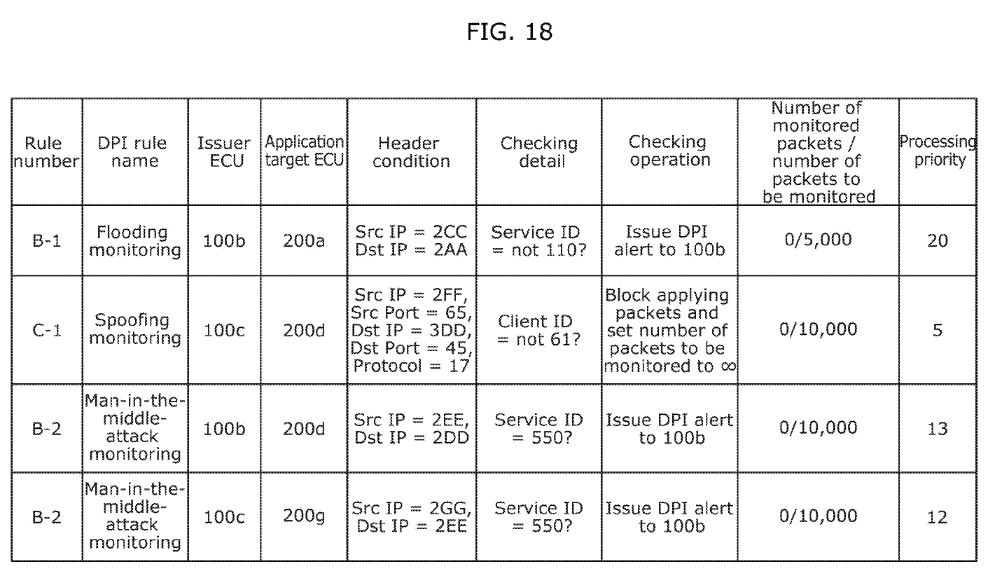

FIG. 18 is a table showing one example of DPI rules generated from anomaly alerts. FIG. 18 shows DPI rules generated from the anomaly alerts in FIG. 15.

Each of rule numbers is set such that a zone ECU that has issued the DPI rule to an application target ECU can be identified. That is, the rule numbers are associated with zone ECUs that have issued the DPI rules. For example, in a case where zone ECU 100b is an issuer, a number including an alphabet letter or the like, such as "B-1", is issued. Note that, for a set of DPI rules relating to "man-in-the-middle-attack monitoring", the same numbers connected with a zone ECU that is to issue a DPI alert are issued.

Checking details and checking operations differ among different details of attacks detected in the flow-base anomaly detection.

For example, in a flooding attack, an attacking ECU is considered to send a large number of communication packets using only a specific service ID. Thus, whether only one service ID is used is checked as a monitoring rule for a flooding attack (flooding monitoring). Specifically, as a checking detail, an application target ECU obtains, from the ECU management list, a service ID of a communication in which an anomaly is detected in the flow-base anomaly detection, and monitors whether any communication having a service ID other than the service ID is being performed. In a case where any communication having the other service ID is found, the application target ECU issues a DPI alert to a zone ECU that is the issuer of the DPI rule, as a checking operation. The zone ECU determines the communication to be an anomalous communication in a case where a given number of issuances of DPI alerts are not received until monitoring of a specified number of packets to be monitored for the flooding monitoring is completed.

For example, as a monitoring rule for a spoofing attack (spoofing monitoring), an application target ECU monitors whether any communication having an improper client ID is being performed. In a case where any communication having an improper client ID is found, the application target ECU determines the communication to be anomalous, blocks packets relating to the communication as a checking operation, and changes the number of packets to be monitored in the DPI rule to an unlimited number (∞).

For example, as a monitoring rule for a man-in-the-middle attack (man-in-the-middle-attack monitoring), application target ECUs check whether an ECU presumed to be an attacker is simultaneously communicating with two ECUs using the same service ID. In a case where the application target ECU confirms that the two ECUs to which DPI rules are applied are performing communications with the specified service ID, the application target ECU issues a DPI alert to the same zone ECU. In a case where the alerts are issued from the two ECUs, the zone ECU determines the communication to be an anomalous communication.

Each number of packets to be monitored is determined based on a detail of an attack to be monitored. For example, in the flooding monitoring, it is anticipated that communication intervals between packets being monitored will become shorter, increasing a processing load. Thus, to reduce the processing load in the flooding monitoring, the number of packets to be monitored is set to be smaller compared with other DPI rules.

### Flowchart of DPI Rule Processing

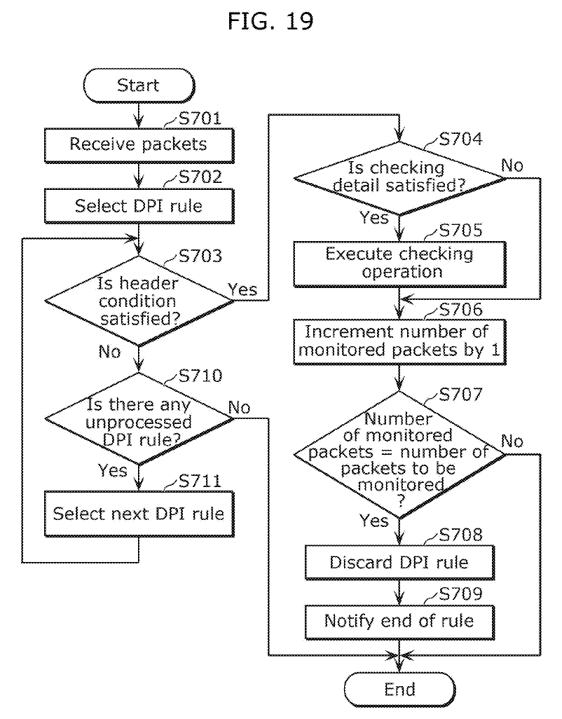

FIG. 19 is a flowchart of DPI rule processing by DPI units 102 and 202. Note that the processing illustrated in FIG. 19 is performed every time a packet is received, for example. DPI units 102 and 202 receive a packet (S701) and selects a DPI rule with the highest processing priority among DPI rules applied to the ECUs of DPI units 102 and 202 (S702). Here, in DPI units 102 and 202, DPI rules are stored beforehand in descending order of processing priority.

DPI units 102 and 202 determine whether the header of the received packet satisfies a header condition included in the selected DPI rule (S703).

In a case where the received packet satisfies the header condition included in the DPI rule (Yes in S703), DPI units 102 and 202 determine whether the packet satisfies a checking detail included in the DPI rule (S704).

In a case where the packet satisfies the checking detail included in the DPI rule (Yes in S704), DPI units 102 and 202 execute a checking operation included in the DPI rule (S705). In a case where the packet does not satisfy the checking detail included in the DPI rule (No in S704), DPI units 102 and 202 skip the process of step S705.

DPI units 102 and 202 then increment the count of the number of monitored packets by 1 (S706).

DPI units 102 and 202 determine whether the number of monitored packets has reached the number of packets to be monitored (S707). In a case where the number of monitored packets has reached the number of packets to be monitored (Yes in S707), DPI units 102 and 202 discard the DPI rule (S708), perform notification of the end of the rule to a zone ECU being an issuer of the DPI rule (S709), and complete the DPI rule processing. In a case where the number of monitored packets has not reached the number of packets to be monitored (No in S707), DPI units 102 and 202 complete the DPI rule processing.

In a case where the received packet does not satisfy the header condition included in the DPI rule (No in S703), DPI units 102 and 202 determine whether any one or more unprocessed DPI rules are present (S710). In a case where any one or more unprocessed DPI rules are present (Yes in S710), DPI units 102 and 202 select a DPI rule with the highest processing priority among the unprocessed DPI rules (S711) and return to step S703. In a case where no unprocessed DPI rule is present (No in S710), DPI units 102 and 202 complete the DPI rule processing as it is.

### One Example of DPI Alert

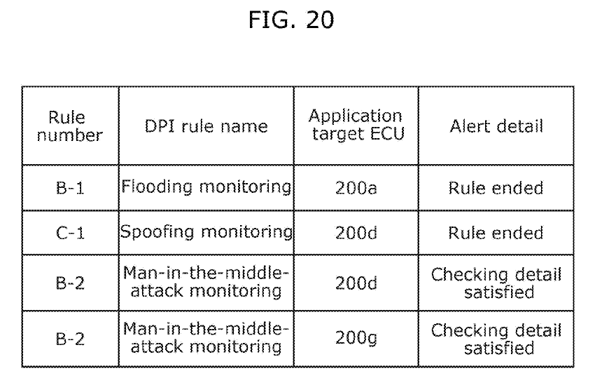

FIG. 20 is a table showing one example of DPI alerts. A DPI alert is issued primarily in a case where in DPI units 102 and 202 the number of monitored packets in the DPI rule satisfies a specified number of monitored packets or notified as checking operations of some DPI rules.

A DPI alert includes a rule number, a DPI rule name, an application target ECU, and an alert detail. The rule number indicates the rule number of the corresponding DPI rule. Checking the rule number, an ECU can thus determine a DPI rule to which the DPI alert pertains.

The DPI rule name indicates the DPI rule name of the DPI rule corresponding to the DPI alert. The application target ECU indicates the application target ECU of the DPI rule corresponding to the DPI alert. The application target ECU is used to grasp an ECU from which the DPI alert is issued.

The alert detail indicates "Rule ended" or "Checking detail satisfied". A DPI alert including "Rule ended" as the alert detail indicates that the number of monitored packets of the DPI rule has satisfied a specified number of monitored packets.

A DPI alert including "Checking detail satisfied" as the alert detail indicates that a checking detail included in the corresponding DPI rule has been satisfied.

For example, the rule numbers "B-1" and "C-1" shown in FIG. 20 each indicate that monitoring under the DPI rule corresponding to the rule number has ended, and that the DPI rule has been discarded by the application target ECU.

For example, the rule number "B-2" shown in FIG. 20 indicates that application target ECUs have received packets satisfying a checking detail included in the corresponding DPI rule. The DPI rule of the rule number "B-2" is "man-in-the-middle-attack monitoring". Thus, the confirmation of a communication in which two ECUs using the same service ID makes it possible to determine the communication being monitored to be an anomalous communication.

### Flowchart of DPI Alert Processing

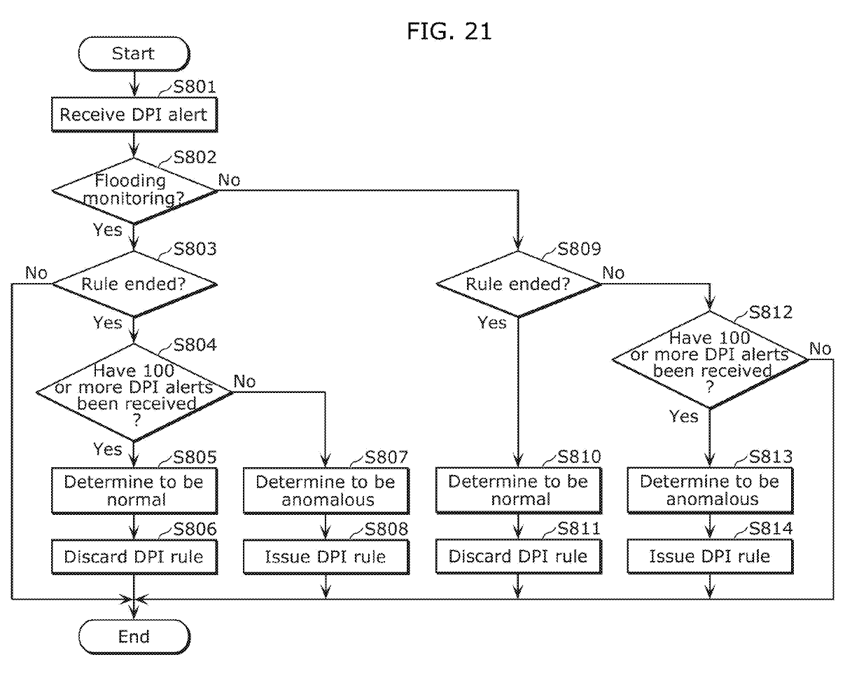

FIG. 21 is a flowchart of DPI alert processing by zone ECUs 100a, 100b, and 100c. DPI alert processor 105C receives a DPI alert (S801).

DPI alert processor 105C determines whether a DPI rule name included in the DPI alert is "flooding monitoring" (S802). In a case where the DPI rule name is "Flooding monitoring" (Yes in S802), DPI alert processor 105C determines whether an alert detail is "Rule ended" (S803). In a case where the alert detail is "Rule ended" (Yes in S803), DPI alert processor 105C determines whether 100 or more DPI alerts that have the same rule number and of which the alert detail is "Checking detail satisfied" have been received (S804).

In a case where the 100 or more DPI alerts of "Checking detail satisfied" have been received (Yes in S804), it can be confirmed that a communication being monitored under the DPI rule with the DPI rule name of "flooding monitoring" is a confirmation with not only a single service ID, and thus DPI alert processor 105C determines the communication to be normal (S805). Since the DPI rule has already been discarded by an application target ECU of the DPI rule, DPI alert processor 105C discards the DPI rule from all-DPI-rule storage 106 of the zone ECU (S806). Here, DPI alert processor 105C instructs the other zone ECUs to discard the rule.

In a case where the 100 or more DPI alerts of "Checking detail satisfied" have not been received (No in S804), DPI alert processor 105C determines that the communication being monitored under the DPI rule to be an anomalous communication having a single service ID (S807). DPI alert processor 105C then discards one or more existing DPI rules from all-DPI-rule storage 106, reissues a DPI rule for disconnecting an anomalous communication (S808), and completes the DPI alert processing.

In a case where the alert detail is not "Rule ended" (No in S803), that is, in a case where the alert detail is "Checking detail satisfied", DPI alert processor 105C completes the DPI alert processing and waits for an issuance of a DPI alert of which the alert detail is "Rule ended".

In a case where the DPI rule name is not "Flooding monitoring" (No in S802), DPI alert processor 105C determines whether an alert detail is "Rule ended" (S809). In a case where the alert detail is "Rule ended" (Yes in S809), nothing special factor of an anomaly has been notified. DPI alert processor 105C thus determines the communication being monitored under the DPI rule to be a normal communication (S810). DPI alert processor 105C then discards the DPI rule from all-DPI-rule storage 106 of the zone ECU (S811).

In a case where the alert detail is not "Rule ended" (No in S809), the DPI alert is found to be a DPI alert of which the DPI rule name is "Man-in-the-middle-attack monitoring" and the alert type is "Checking detail satisfied".

DPI alert processor 105C determines whether "Checking detail satisfied" with the same rule number and a different DPI rule name has been received (S812). In a case where "Checking detail satisfied" with the same rule number and the different DPI rule name has been received (Yes in S812), it is confirmed that an attacker ECU is performing a communication having the same service ID. DPI alert processor 105C thus determines that the communication being monitored under the DPI rule to be an anomalous communication (S813). DPI alert processor 105C then discards one or more existing DPI rules from all-DPI-rule storage 106, reissues a DPI rule for disconnecting an anomalous communication (S814), and completes the DPI alert processing.

In a case where "Checking detail satisfied" with the same rule number and the different DPI rule name has not been received (No in S812), DPI alert processor 105C completes the DPI alert processing and waits for an issuance of the next DPI alert.

### One Example of DPI Rules for Disconnecting Anomalous Communication

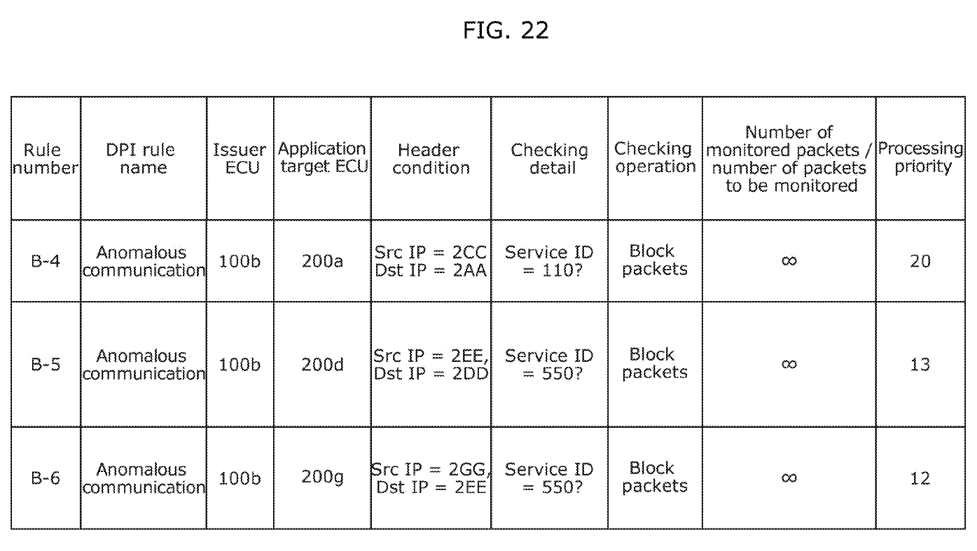

FIG. 22 is a table showing one example of DPI rules for disconnecting an anomalous communication. In FIG. 22, "Anomalous communication" is shown as DPI rule names.

As header conditions, header information items on anomalous communications are specified. As checking details, for example, checking of service IDs or client IDs used in the anomalous communications are specified. As checking operations, processing for blocking packets of a communication that falls under one of the specified details is specified as a checking operation.

The numbers of packets to be monitored are set to an unlimited number (∞). This prevents the DPI units of application target ECUs from discarding DPI rule. Although processing priorities are desirably recalculated for the packets falling under the respective checking details, the processing priorities of original DPI rules may be directly used.

### Embodiment 2

Hereinafter, an anomaly detection device (anomaly detection system) for a vehicle equipped with an in-vehicle network in which a plurality of Electronic Control Units (ECUs) communicate with one another over Ethernet (in-vehicle network system) will be described. Note that constituent components having the same function as those in Embodiment 1 will be given the reference characters, and the description thereof will be omitted.

### Overall Configuration Diagram of In-vehicle Network System

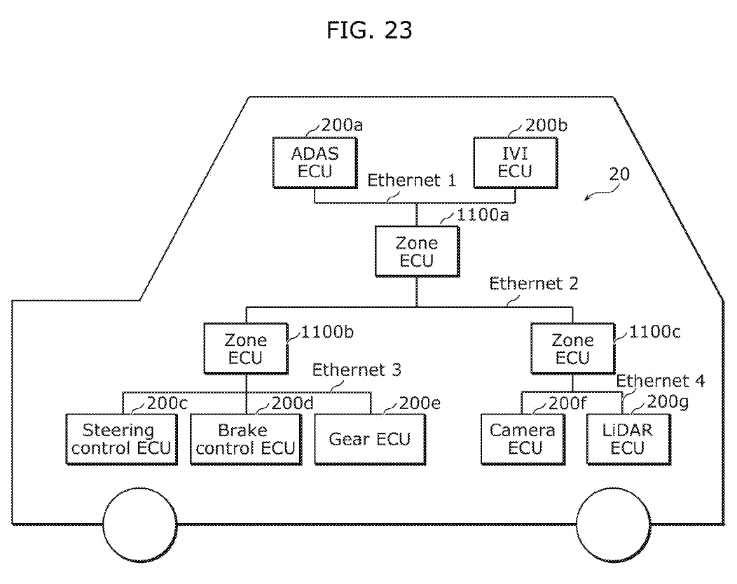

FIG. 23 is an overall configuration diagram of in-vehicle network system 20. As seen in FIG. 23, in-vehicle network system 20 includes ADAS ECU 200a, IVI ECU 200b, steering control ECU 200c, brake control ECU 200d, gear ECU 200e, camera ECU 200f, LiDAR ECU 200g, and zone ECUs 1100a, 1100b, and 1100c.

### Configuration Diagram of Zone ECU 1100a

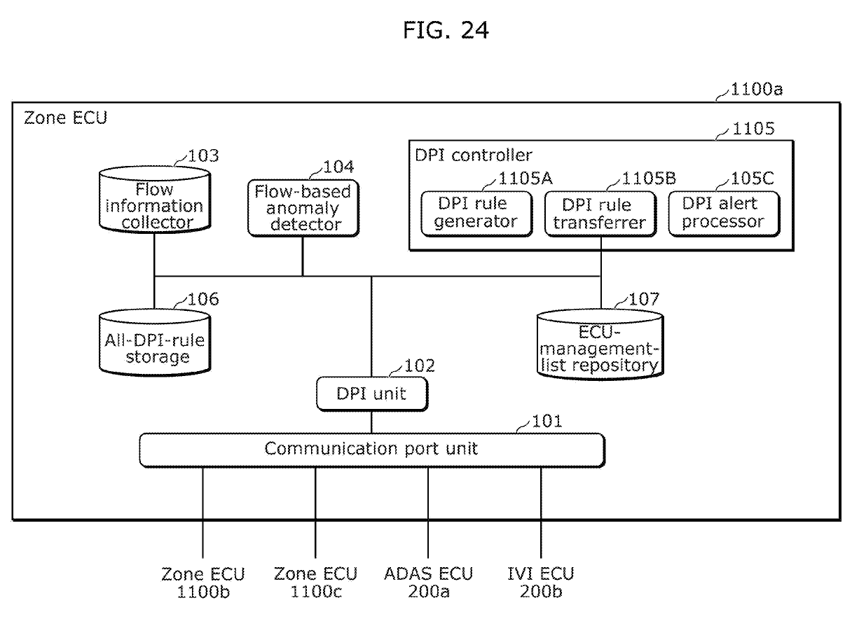

FIG. 24 is a configuration diagram of zone ECU 1100a. Note that zone ECUs 1100b and 1100c have substantially the same configuration as zone ECU 1100a, and thus, the description thereof will be omitted.

As seen in FIG. 24, zone ECU 1100a includes communication port unit 101, DPI unit 102, flow information collector 103, flow-based anomaly detector 104, DPI controller 1105, all-DPI-rule storage 106, and ECU-management-list repository 107.

DPI controller 1105 includes DPI rule generator 1105A, DPI rule transferrer 1105B, and DPI alert processor 105C.

DPI rule generator 1105A generates a DPI rule based on an anomaly alert outputted by flow-based anomaly detector 104 or a DPI alert outputted by the DPI unit of each ECU. DPI rule generator 1105A determines a header condition, a checking detail, a checking operation, and the number of packets to be monitored to be included in the DPI rule.

DPI rule transferrer 1105B determines an application target of the DPI rule generated by DPI rule generator 1105A based on the processing load statuses of ECUs and transfers the DPI rule to the determined application target ECU. For example, in a case of monitoring a communication between ADAS ECU 200a and steering control ECU 200c, the generated DPI rule is transferred to zone ECU 1100a or zone ECU 1100b instead of ADAS ECU 200a in a case where the number of packets monitored by DPI unit 202 of ADAS ECU 200a exceeds a specified value.

To determine the application target of the DPI rule, DPI rule transferrer 1105B receives, from flow information collector 103, the number of communication packets of an ECU that is a candidate for the application target and the number of packets to be monitored by the DPI unit. Based on these information items, DPI rule transferrer 1105B determines the application target of the DPI rule and also calculates the processing priority of the DPI rule.

### Processing Sequence

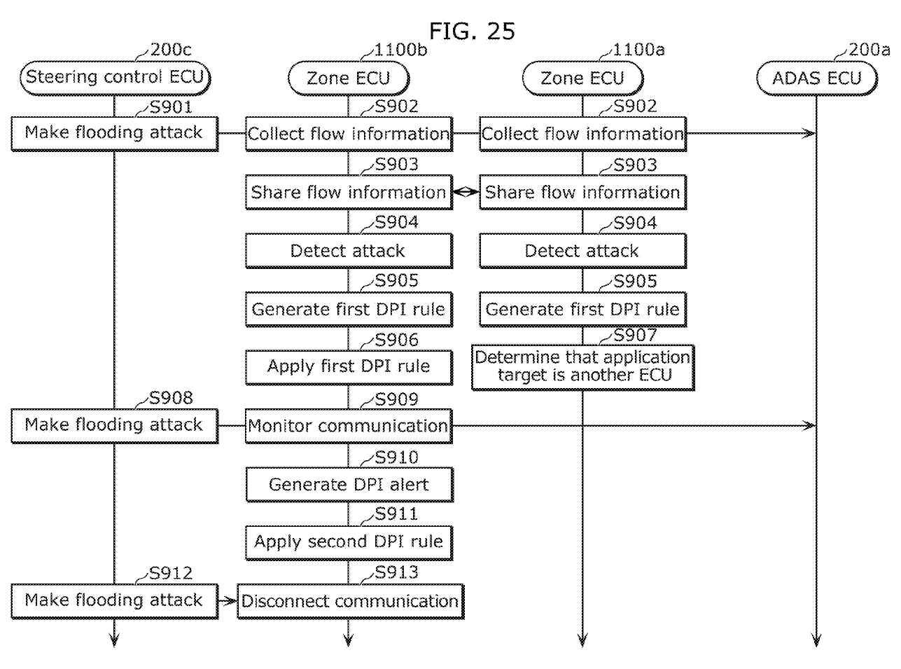

FIG. 25 is a diagram illustrating a processing sequence for a case of the occurrence of an attack from steering control ECU 200c to ADAS ECU 200a according to Embodiment 2. In FIG. 25, zone ECUs 1100b and 1100c each collect flow information with flow information collector 103, perform anomaly detection with flow-based anomaly detector 104, generate a DPI rule with DPI rule generator 1105A based on a result of the anomaly detection, determine an application target of the DPI rule based on the processing load statuses of ECUs, and perform security response based on a result of monitoring under the applied DPI rule.

Steering control ECU 200c makes a flooding attack on ADAS ECU 200a (S901). Zone ECUs 1100a and 1100b, which are present on a communication route between steering control ECU 200c and ADAS ECU 200a, mirror packets and receive the packets, thus collecting the flow information (S902).

Zone ECUs 1100a, 1100b, and 1100c share the flow information collected by zone ECUs 1100a, 1100b, and 1100c (S903). Note that the processing by zone ECU 1100c is not illustrated in FIG. 25.

Based on the shared flow information, zone ECUs 1100a, 1100b, and 1100c perform flow-base anomaly detection, thus detecting that steering control ECU 200c is attacking ADAS ECU 200a (S904). Based on a result of the flow-base anomaly detection, zone ECUs 1100a, 1100b, and 1100c each generate a first DPI rule for monitoring the communication (S905).

Zone ECU 1100b selects, as candidates for an application target of the generated first DPI rule, ADAS ECU 200a, steering control ECU 200c, zone ECU 1100a, and zone ECU 1100b, checks processing loads of the ECUs from the flow information, determines the zone ECU 1100b as the application target of the DPI rule based on a result of the check, and applies the first DPI rule (S906).

From the flow information, zone ECU 1100a determines that the application target of the generated first DPI rule is zone ECU 1100b (S907). Note that how to make the determination is the same as in S906.

Steering control ECU 200c continues making the flooding attack on ADAS ECU 200a (S908). Zone ECU 1100b monitors the payloads of packets according to the first DPI rule applied to DPI unit 102 (S909).

Based on a result of the monitoring by DPI unit 102, zone ECU 1100b generates a DPI alert (S910). Based on the generated DPI alert, zone ECU 1100b formally determines the communication made by steering control ECU 200c to be an anomalous communication and applies a second DPI rule for disconnecting the anomalous communication to DPI unit 102 of zone ECU 1100b (S911).

Steering control ECU 200c continues making the flooding attack on ADAS ECU 200a (S912). According to the second DPI rule, DPI unit 102 of zone ECU 1100b disconnects the anomalous communication from steering control ECU 200c to ADAS ECU 200a (S913).

### Flowchart of Generating DPI Rule

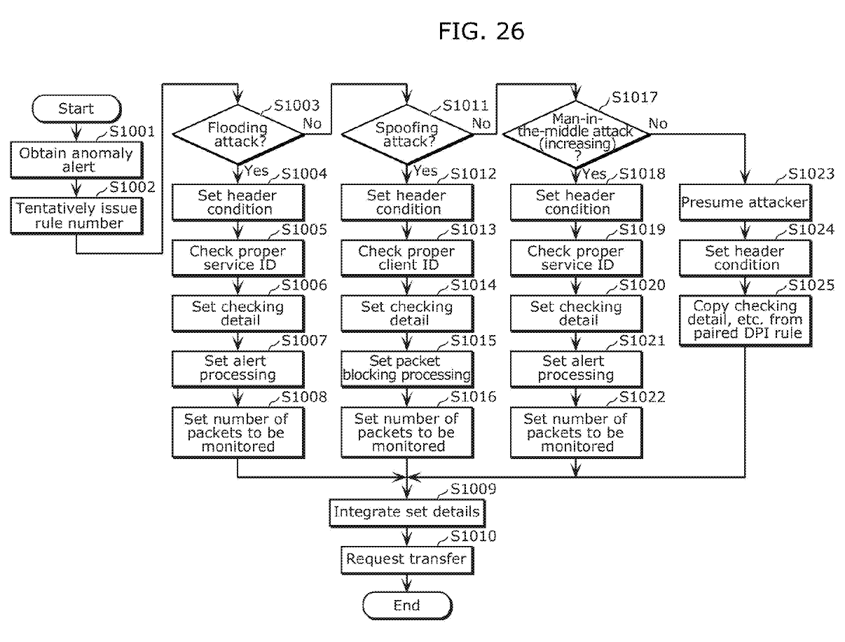

FIG. 26 is a flowchart of DPI rule generation processing. DPI rule generator 1105A obtains an anomaly alert generated by flow-based anomaly detector 104 (S1001). DPI rule generator 1105A tentatively issues a rule number of a DPI rule (S1002).

DPI rule generator 1105A determines whether an alert type included in a DPI alert is "flooding attack" (S1003). In a case where the alert type is "flooding attack" (Yes in S1003), DPI rule generator 1105A sets a source IP address and a destination IP address assigned to a flow ID included in the anomaly alert as a header condition included in the DPI rule (S1004).

DPI rule generator 1105A then refers to the ECU management list to check a proper service ID from the flow ID (S1005) and sets a checking detail included in the DPI rule using the checked service ID (S1006). DPI rule generator 1105A sets, as a checking operation included in the DPI rule, a process of issuing an alert to a zone ECU that has been issued the DPI rule (S1007). DPI rule generator 1105A sets the number of packets to be monitored included in the DPI rule to a value necessary to monitor the flooding attack (S1008). DPI rule generator 1105A then integrates the details that have been set thus far into one DPI rule (S1009).

DPI rule generator 1105A requests DPI rule transferrer 1105B to determine an application target of the generated DPI rule, determine the processing priority of the DPI rule, and transfer the DPI rule (S1010), and completes the DPI rule generation processing.

In a case where the alert type is not "flooding attack" (No in S1003), DPI rule generator 1105A determines whether the alert type included in the anomaly alert is "spoofing attack" (S1011). In a case where the alert type is "spoofing attack" (Yes in S1011), DPI rule generator 1105A sets the flow ID included in the anomaly alert as the header condition included in the DPI rule (S1012). DPI rule generator 1105A then refers to the ECU management list to check a proper client ID from the flow ID (S1013) and sets a checking detail included in the DPI rule using the checked client ID (S1014).

DPI rule generator 1105A sets, as a checking operation included in the DPI rule, a process of blocking packets with the flow ID and resetting the number of packets to be monitored by the application target ECU to an unlimited number (∞) (S1015). DPI rule generator 1105A sets the number of packets to be monitored included in the DPI rule to a value necessary to monitor the spoofing attack (S1016). DPI rule generator 1105A then integrates the details that have been set thus far into one DPI rule (S1009), makes a request for transfer of the DPI rule (S1010), and completes the DPI rule generation processing.

In a case where the alert type is not "spoofing attack" (No in S1011), DPI rule generator 1105A determines whether the alert type included in the anomaly alert is "man-in-the-middle attack (increasing)" (S1017). In a case where the alert type is "man-in-the-middle attack (increasing)" (Yes in S1017), DPI rule generator 1105A sets the source IP address and the destination IP address assigned to the flow ID included in the anomaly alert as a header condition included in the DPI rule (S1018).

DPI rule generator 1105A then refers to the ECU management list to check a proper service ID from the flow ID (S1019) and sets a checking detail included in the DPI rule using the checked service ID (S1020). DPI rule generator 1105A sets, as a checking operation included in the DPI rule, a process of issuing an alert to a zone ECU that has been issued the DPI rule (S1021). DPI rule generator 1105A sets the number of packets to be monitored included in the DPI rule to a value necessary to monitor the man-in-the-middle attack (S1022). DPI rule generator 1105A then integrates the details that have been set thus far into one DPI rule (S1009), makes a request for transfer of the DPI rule (S1010), and completes the DPI rule generation processing.

In a case where the alert type is not "man-in-the-middle attack (increasing)" (No in S1017), DPI rule generator 1105A determines whether the alert type included in the DPI rule is "man-in-the-middle attack (decreasing)". DPI rule generator 1105A presumes that an ECU with a source IP address assigned to a flow ID included in an anomaly alert that has the same alert number and of which the alert type is "man-in-the-middle attack (increasing)" is an attacking ECU (S1023). DPI rule generator 1105A extracts a source ECU from the flow ID included in the anomaly alert of which the alert type is "man-in-the-middle attack (decreasing)" and a tuple including the IP addresses of the source ECU and the presumed attacking ECU (the attacking ECU is located on a destination side) as the header condition of the DPI rule (S1024). DPI rule generator 1105A sets a checking detail, a checking operation, and the number of packets to be monitored included in DPI rule such that they become the same as those of a paired DPI rule, that is, a DPI rule that has the same alert number and is generated from an anomaly alert of which the alert type is "man-in-the-middle attack (increasing)" (S1025). DPI rule generator 1105A then integrates the details that have been set thus far into one DPI rule (S1009), requests DPI rule transferrer 1105B to transfer the DPI rule (S1010), and completes the DPI rule generation processing.

### Flowchart of DPI Rule Transfer Processing

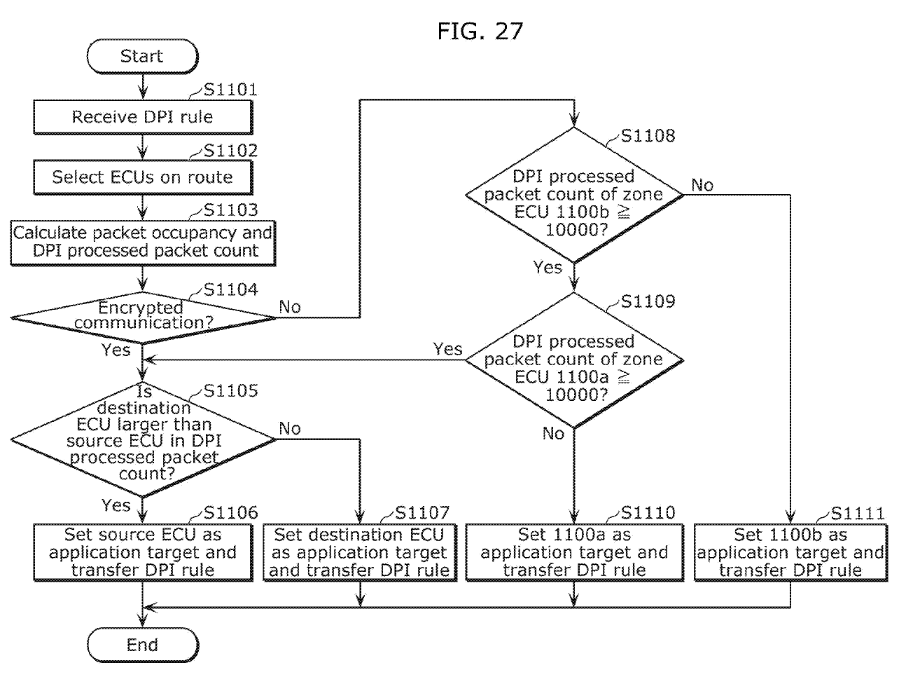

FIG. 27 is a flowchart of DPI rule transfer processing. DPI rule transferrer 1105B receives a DPI rule generated by DPI rule generator 1105A (S1101).

DPI rule transferrer 1105B selects ECUs on a route through which packets to be monitored under the DPI rule (S1102). The ECUs present on the route include a source ECU and a destination ECU of the packets to be monitored and one or more zone ECUs present on a communication route between the source ECU and the destination ECU. In FIG. 27, zone ECUs 1100a and 1100b are selected as the one or more zone ECUs on the route. In addition, zone ECU 1100b is assumed to be a zone ECU to manage the source ECU.

DPI rule transferrer 1105B requests flow information from each of the selected ECUs and calculates, for each ECU, a packet occupancy and a DPI processed packet count, which is the number of packets subjected to payload monitoring processing by a DPI unit per minute (S1103).

DPI rule transferrer 1105B determines whether the packets to be monitored under the DPI rule are communicated in an encrypted form (S1104). In a case where the packets to be monitored are communicated in an encrypted form (Yes in S1104), DPI rule transferrer 1105B narrows, as candidates for an application target of the DPI rule, the ECUs into the source ECU and the destination ECU, which are capable of decrypting the packets communicated in the encrypted form, and determines whether the DPI processed packet count of the destination ECU is greater than that of the source ECU (S1105). In a case where the DPI processed packet count of the destination ECU is greater than that of the source ECU (Yes in S1105), DPI rule transferrer 1105B sets the source ECU as the application target of the DPI rule, sets the packet occupancy of the source ECU as the processing priority of the DPI rule, and transfers the DPI rule to the application target ECU (S1106). DPI rule transferrer 1105B then completes the DPI rule transfer processing.

In a case where the DPI processed packet count of the destination ECU is less than that of the source ECU (No in S1105), DPI rule transferrer 1105B sets the destination ECU as the application target of the DPI rule, sets the packet occupancy of the destination ECU as the processing priority of the DPI rule, and transfers the DPI rule to the application target ECU (S1107). DPI rule transferrer 1105B then completes the DPI rule transfer processing.

In a case where the packets to be monitored are not communicated in an encrypted form (No in S1104), the packets can be monitored by the zone ECUs without the decryption of the packets. Thus, DPI rule transferrer 1105B determines whether the DPI processed packet count of zone ECU 1100b, which manages the source ECU, is greater than or equal to 10000 (S1108). In a case where the DPI processed packet count of zone ECU 1100b is greater than or equal to 10000 (Yes in S1108), DPI rule transferrer 1105B determines whether the DPI processed packet count of zone ECU 1100a, which is the other candidate zone ECU for the application target, is greater than or equal to 10000 (S1109). In a case where the DPI processed packet count of zone ECU 1100a is greater than or equal to 10000 (Yes in S1109), it is difficult for the zone ECU to perform the monitoring. Thus, DPI rule transferrer 1105B performs step S1105.

In a case where the DPI processed packet count of zone ECU 1100a is less than 10000 (No in S1109), zone ECU 1100a can perform the monitoring. Thus, DPI rule transferrer 1105B sets the zone ECU 1100a as the application target of the DPI rule, sets the packet occupancy of zone ECU 1100a as the processing priority of the DPI rule, and transfers the DPI rule to the application target ECU (S1110). DPI rule transferrer 1105B then completes the DPI rule transfer processing.

In a case where the DPI processed packet count of zone ECU 1100b is less than 10000 (No in S1108), zone ECU 1100b can perform the monitoring. Thus, DPI rule transferrer 1105B sets zone ECU 1100b as the application target of the DPI rule, sets the packet occupancy of zone ECU 1100b as the processing priority of the DPI rule, and transfers the DPI rule to the application target ECU (S1111). DPI rule transferrer 1105B then completes the DPI rule transfer processing.

### One Example of Flow Information Requested for Determining Application Target and Processing Priority

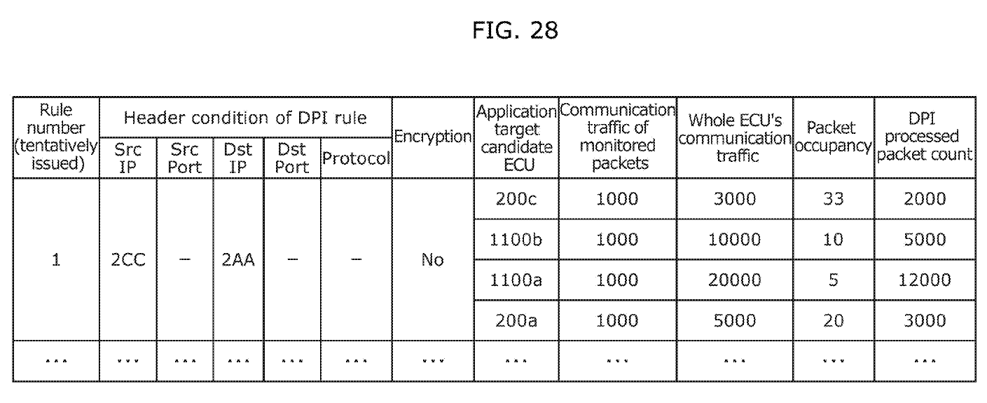

FIG. 28 is a table showing one example of flow information that DPI rule transferrer 1105B requests flow information collector 103 for determining an application target and a processing priority of a DPI rule.

In the determination of the application target of the DPI rule, DPI rule transferrer 1105B performs notification of the header condition of packets to be monitored under the DPI rule to flow information collector 103. Flow information collector 103 selects an ECU that can monitor the packets with the notified header condition, extracts, from collected flow information items, a flow information item to be used as a comparison condition for determining the application target of the DPI rule and a flow information item for determining the processing priority, and transfers the extracted flow information items to DPI rule transferrer 1105B.

As seen in FIG. 28, the flow information items requested from flow information collector 103 are associated with a rule number that has been tentatively issued in the generation of the DPI rule.

In FIG. 28, the flow information items each include the presence or absence of encryption, the communication traffic of monitored packets, a candidate ECU for the application target of the DPI rule, the communication traffic of the candidate ECU as a whole, the packet occupancy of monitored packets, and the DPI processed packet count of the candidate ECU.

The presence or absence of encryption indicates whether a communication falling under the notified header condition is encrypted. The presence or absence of encryption is determined from the combination of a source ECU and a destination ECU. The communication traffic of monitored packets indicates the communication traffic of packets that are communicated over in-vehicle network system 20 and fall under the header condition.

The application target candidate ECU indicates an ECU through which the monitored packets pass in the communication. The packet occupancy indicates the ratio (%) of the number of monitored packets to the number of packets communicated by the application target candidate ECU as a whole. That is, the packet occupancy indicates the proportion of the number of monitored packets to the number of packets communicated by the application target candidate ECU as a whole. This value is set as the processing priority of the DPI rule after the application target is determined.

The DPI processed packet count indicates the number of packets on which the DPI unit of the application target candidate ECU is currently performing payload monitoring processing according to the DPI rule. Flow information collector 103 obtains information on DPI rules applied to the ECUs from all-DPI-rule storage 106 to calculate the DPI processed packet count. A larger value of the DPI processed packet count indicates that a processing load of the DPI unit of each ECU is high. Note that the definition of the DPI processed packet count is not limited to the above definition. For example, the DPI processed packet count may be the number of times DPI units 102 and 202 check the DPI rule against the header of received packets.

### One Example of DPI Rule of which Application Target is Dynamically Changed

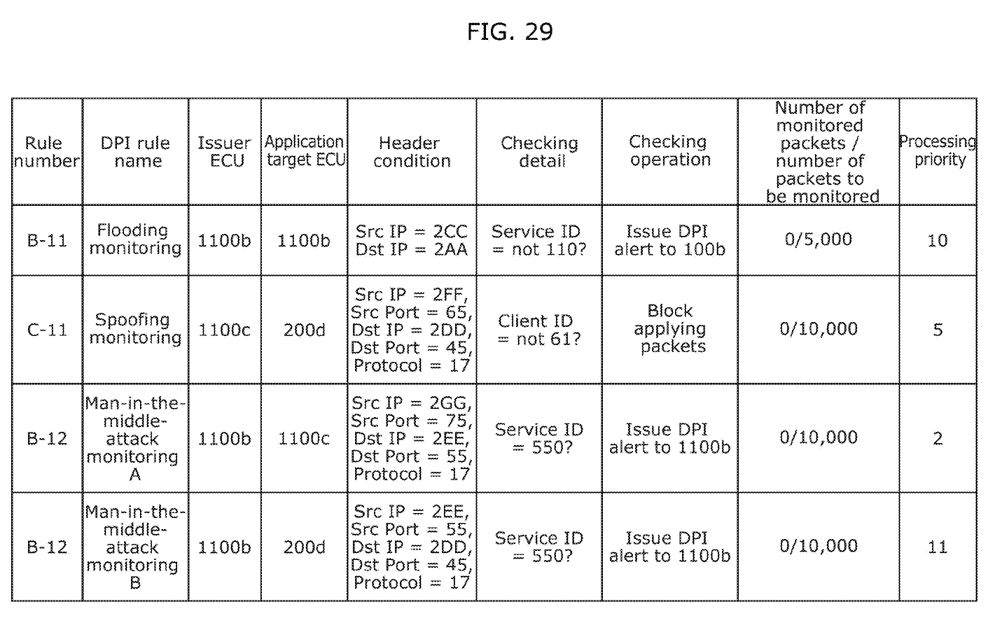

FIG. 29 is a table showing one example of a DPI rule of which the application target is dynamically changed. For example, the DPI rule with the rule number "B-11" shown in FIG. 29 is applied to zone ECU 1100b, which is the issuer of the DPI rule. For rule number "B-12", two DPI rules are generated because rule number "B-12" is the rule number of DPI rules for man-in-the-middle-attack monitoring. One of the DPI rules is applied to zone ECU 1100c, and the other is applied to brake control ECU 200d.

### Embodiment 3

Hereinafter, an anomaly detection device (anomaly detection system) for a vehicle equipped with an in-vehicle network in which a plurality of electronic control units (ECUs) communicate with one another over Ethernet (in-vehicle network system) will be described. Note that constituent components having the same function as those in Embodiment 1 will be given the reference characters, and the description thereof will be omitted.

### Overall Configuration Diagram of In-vehicle Network System

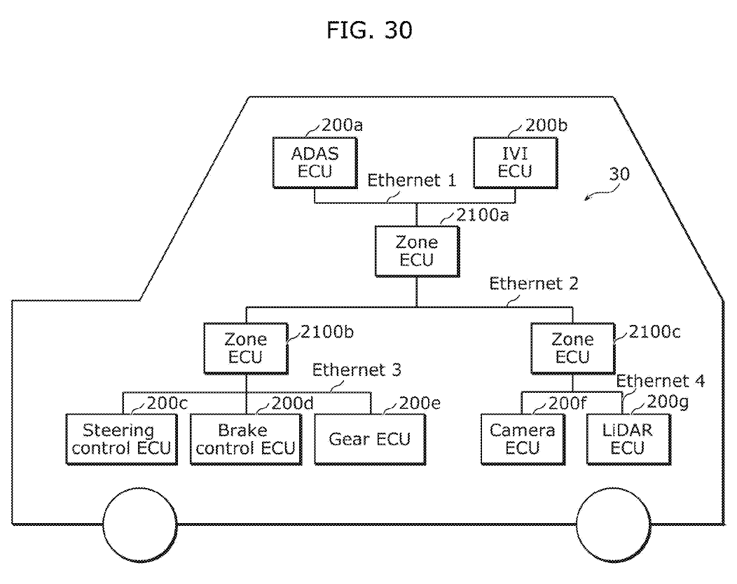

FIG. 30 is an overall configuration diagram of in-vehicle network system 30. As seen in FIG. 30, in-vehicle network system 30 includes ADAS ECU 200a, IVI ECU 200b, steering control ECU 200c, brake control ECU 200d, gear ECU 200e, camera ECU 200f, LiDAR ECU 200g, and zone ECUs 2100a, 2100b, and 2100c.

### Configuration Diagram of Zone ECU 2100a

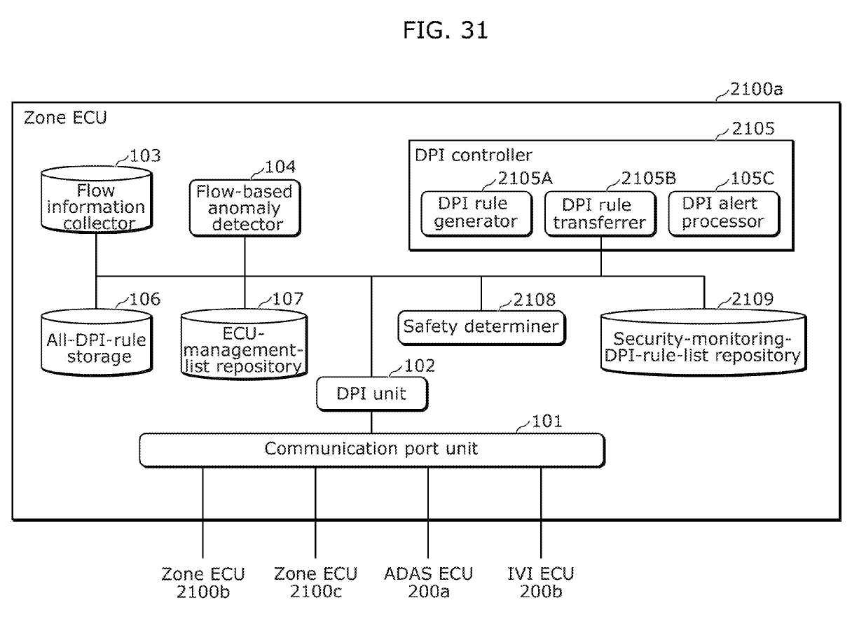

FIG. 31 is a configuration diagram of zone ECU 2100a. Note that zone ECUs 2100b and 2100c have substantially the same configuration as zone ECU 2100a, and thus, the description thereof will be omitted.

As seen in FIG. 31, zone ECU 2100a includes communication port unit 101, DPI unit 102, flow information collector 103, flow-based anomaly detector 104, DPI controller 2105, all-DPI-rule storage 106, ECU-management-list repository 107, safety determiner 2108, security-monitoring-DPI-rule-list repository 2109.

DPI controller 2105 includes DPI rule generator 2105A, DPI rule transferrer 2105B, and DPI alert processor 105C.

DPI rule generator 2105A generates a DPI rule from an anomaly alert generated by flow-based anomaly detector 104. DPI rule generator 2105A also generates a DPI rule under an instruction from safety determiner 2108.

Safety determiner 2108 determines whether there is a risk to the life of a driver from the anomaly alert from flow-based anomaly detector 104 and a vehicle state received from ADAS ECU 200a and gear ECU 200e and issues a command to secure the safety of the driver to the ECUs as necessary. In a case where there is a risk of an attack on a function pertaining to the safety of the driver, safety determiner 2108 instructs DPI rule generator 2105A to generate a DPI rule for monitoring a communication of an ECU with the function.

In security-monitoring-DPI-rule-list repository 2109, templates of DPI rules that are to be generated under instructions from safety determiner 2108 are saved in advance. Receiving an instruction to generate a DPI rule from safety determiner 2108, DPI rule generator 2105A calls a template of the DPI rule from security-monitoring-DPI-rule-list repository 2109 and generates the DPI rule using the template, rather than creating the DPI rule from scratch.

### Security Monitoring DPI Rule List

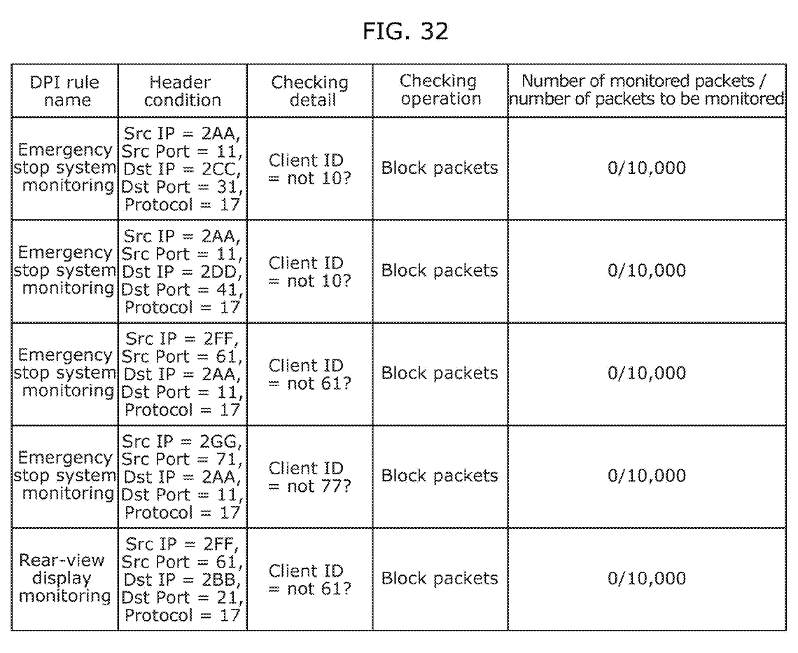

FIG. 32 is a table showing one example of a security monitoring DPI rule list that is saved in security-monitoring-DPI-rule-list repository 2109. DPI rules saved in the security monitoring DPI rule list each include a DPI rule name, a header condition, a checking detail, a checking operation, and the number of packets to be monitored. Under an instruction from safety determiner 2108, DPI rule generator 2105A requests a necessary DPI rule from security-monitoring-DPI-rule-list repository 2109.

In the example shown in FIG. 32, two types of DPI rules of which the DPI rule names are emergency stop system monitoring and rear-view display monitoring. The DPI rules named emergency stop system monitoring are DPI rules that are generated in a case where safety determiner 2108 determines to start a system of bringing the vehicle to an emergency stop, from an anomaly alert outputted from flow-based anomaly detector 104. The DPI rules are used to determine whether a control system ECU, a sensor system ECU, or the like, which is used to bring the vehicle to an emergency stop, is subjected to a malicious communication under a spoofing attack by a malicious ECU. As a result, packets of a communication using an improper client ID are blocked, and thus the functions of the vehicle are protected.

The DPI rule named rear-view display monitoring is generated in a case where an anomaly alert is raised for a communication with the IVI ECU while a gear is in a reverse (R) position. Under the DPI rule, whether any communication having an improper client ID is being performed with a rear-view display, which is being watched by the driver for rearward visibility in parking, is monitored, and communication packets having the anomalous client ID are blocked by DPI units 102 and 202.

### Processing Sequence

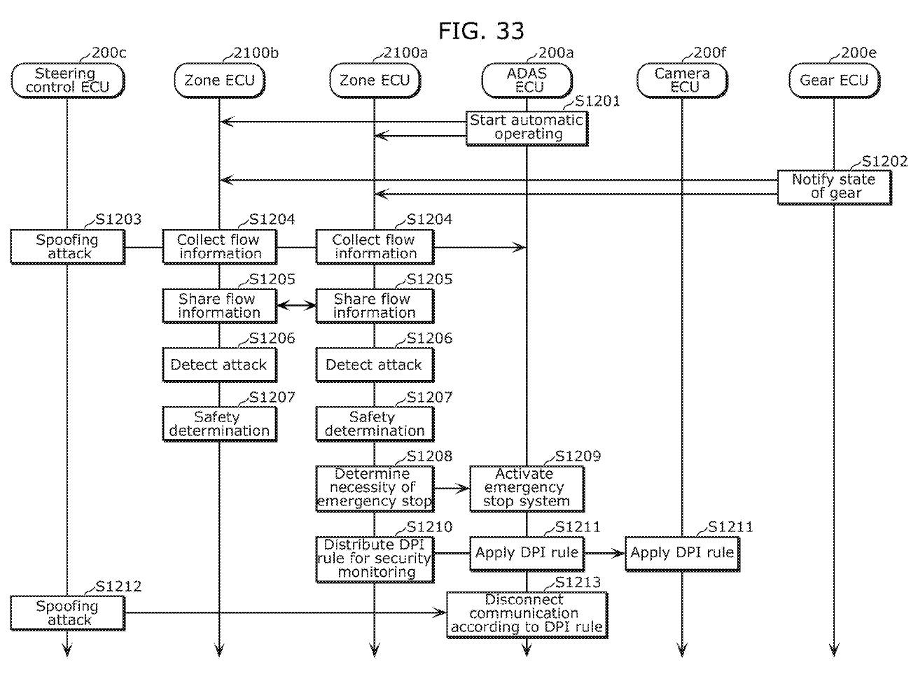

FIG. 33 is a diagram illustrating a processing sequence for a case of the occurrence of an attack from steering control ECU 200c to ADAS ECU 200a according to Embodiment 3. In FIG. 33, a DPI rule for monitoring the activation an emergency stop system and a communication performed by functions of the emergency stop system is applied, and security response is performed based on a result of the monitoring by DPI units.

ADAS ECU 200a starts automated operating and performs notification of the start of the automated operating to zone ECUs 2100a, 2100b, and 2100c (S1201). Gear ECU 200e periodically performs notification of the state of the gear to zone ECUs 2100a, 2100b, and 2100c (S1202). Note that the processing by zone ECU 2100c is not illustrated in FIG. 33.

Steering control ECU 200c makes a spoofing attack on ADAS ECU 200a (S1203). Zone ECUs 2100a and 2100b, which are present on a communication route between steering control ECU 200c and ADAS ECU 200a, mirror packets and receive the packets, thus collecting the flow information (S1204).

Zone ECUs 2100a, 2100b, and 2100c share the flow information collected by zone ECUs 2100a, 2100b, and 2100c (S1205). Based on the shared flow information, zone ECUs 2100a, 2100b, and 2100c perform flow-base anomaly detection, thus detecting that steering control ECU 200c is attacking ADAS ECU 200a (S1206).

Zone ECUs 2100a, 2100b, and 2100c perform safety determination for determining whether a detail of an anomaly alert generated in the flow-base anomaly detection indicates a threat to the safety of the vehicle (S1207). Specifically, zone ECUs 2100a, 2100b, and 2100c perform the safety determination in such a manner as to compare the detail of the anomaly alert with the vehicle state notified from ADAS ECU 200a and gear ECU 200e.

Determining that continuing the automated operating involves risk as a result of the safety determination, zone ECU 2100a performs an emergency stop and commands ADAS ECU 200a to stop an automated operating system (S1208).

ADAS ECU 200a activates the emergency stop system under an instruction from zone ECU 2100a, which manages ADAS ECU 200a (S1209). To activate the emergency stop system safely, zone ECU 2100a distributes a DPI rule for monitoring any anomalous communication to ECUs pertaining to the emergency stop (S1210).

ADAS ECU 200a and camera ECU 200f receive the DPI rule from zone ECU 2100a and apply the received DPI rule to their DPI units 202 (S1211).

Steering control ECU 200c continues making the spoofing attack on ADAS ECU 200a (S1212). ADAS ECU 200a disconnects the anomalous communication from steering control ECU 200c according to the DPI rule (S1213).

### Packet Processing by Zone ECU

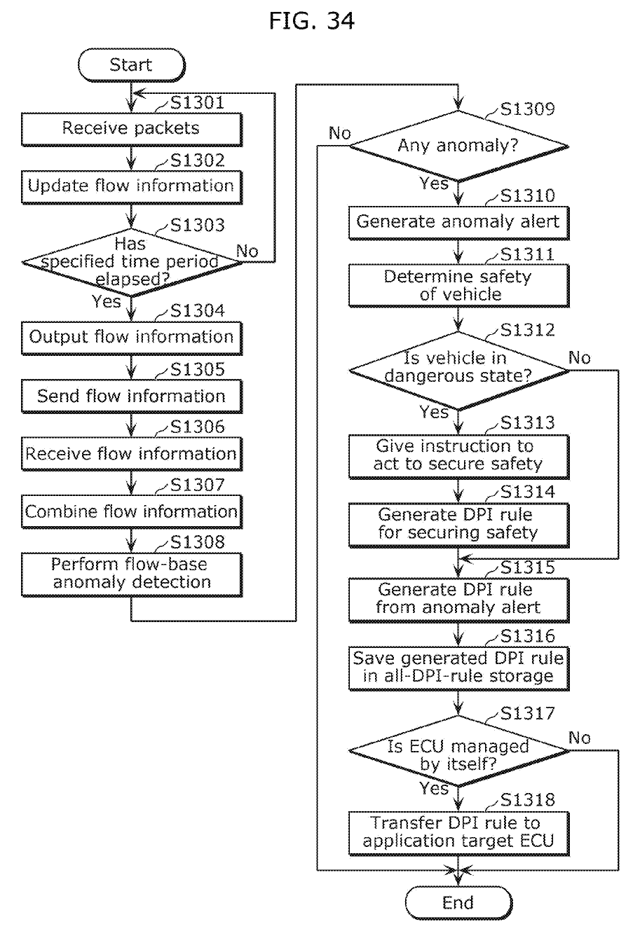

FIG. 34 is a flowchart of processing performed in a case where a zone ECU according to Embodiment 3 receives packets. Communication port unit 101 mirrors and receives packets that pass through itself (S1301). Flow information collector 103 extracts header information from the received packets to update the flow information (S1302).

Flow information collector 103 determines whether a specified time period of collecting the flow information has elapsed (S1303). In a case where the specified time period has elapsed (Yes in S1303), flow information collector 103 outputs the flow information (S1304). In a case where the specified time period has not elapsed (No in S1303), flow information collector 103 returns to the first step S1301.

Communication port unit 101 transfers the outputted flow information to other zone ECUs (S1305). Communication port unit 101 also receives flow information transferred from the other zone ECUs (S1306). Flow information collector 103 then combines the flow information outputted by itself and the flow information transferred from the other zone ECUs (S1307).

Flow-based anomaly detector 104 performs the flow-base anomaly detection based on the combined flow information (S1308) and determines whether any anomaly has occurred (S1309). In a case where any anomaly has occurred (Yes in S1309), flow-based anomaly detector 104 generates an anomaly alert in which a detail of the anomaly is written (S1310). In a case where no anomaly has occurred (No in S1309), the zone ECU completes the processing.

DPI rule generator 2105A compares the detail of the generated anomaly alert with the vehicle state to determine whether the detail of the anomaly alert indicates a threat to the safety of the vehicle (S1311).

From a result of the determination as to the safety, DPI rule generator 2105A determines whether the vehicle is in a dangerous state (S1312).

In a case where the vehicle is determined to be in a dangerous state (Yes in S1312), DPI rule generator 2105A instructs ECUs to act to secure safety (S1313), and generates a DPI rule for securing the safety of the vehicle (S1314). In a case where the vehicle is determined to be not in a dangerous state (No in S1312), DPI rule generator 2105A skips the processes of steps S1313 and S1314.

From the generated anomaly alert, DPI rule generator 2105A generates a DPI rule (S1315). DPI rule generator 2105A saves the generated DPI rule in all-DPI-rule storage 106 (S1316).

DPI rule transferrer 2105B determines whether an application target ECU of the generated DPI rule is an ECU managed by the zone ECU based on the ECU management list (S1317). In a case where the application target ECU is an ECU managed by the zone ECU (Yes in S1317), DPI rule transferrer 2105B transfers the DPI rule to the application target ECU (S1318), and the zone ECU completes the processing. In a case where the application target ECU is not an ECU managed by the zone ECU (No in S1317), the zone ECU completes the processing.

### Flowchart of Processing for Safety Determination

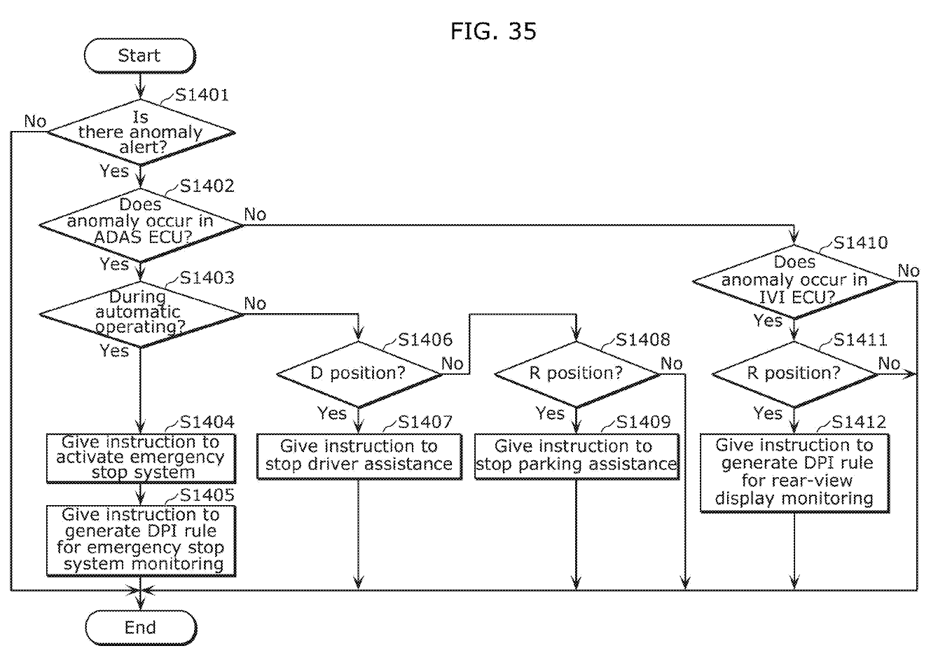

FIG. 35 is a flowchart of processing for the safety determination. Safety determiner 2108 determines whether there is any anomaly alert from flow-based anomaly detector 104 (S1401). In a case where an anomaly alert is present (Yes in S1401), safety determiner 2108 determines whether a communication that has caused the anomaly alert is a communication with ADAS ECU 200a (S1402).

In a case where the communication having caused the anomaly alert is a communication with ADAS ECU 200a (Yes in S1402), safety determiner 2108 determines whether the automated operating is being performed (S1403). In a case where the automated operating is being performed (Yes in S1403), safety determiner 2108 instructs ADAS ECU 200a to activate the emergency stop system and notifies the driver that the emergency stop system will be activated (S1404). Safety determiner 2108 then instructs DPI rule generator 2105A to generate a DPI rule for monitoring the emergency stop system monitoring (S1405).

In a case where the automated operating is not being performed (No in S1403), safety determiner 2108 determines whether the gear is in a drive (D) position (S1406). In a case where the gear is in the D position (Yes in S1406), safety determiner 2108 instructs ADAS ECU 200a to stop driver assistance and notifies the driver that the driver assistance will be stopped (S1407).

In a case where the gear is not in the D position (No in S1406), safety determiner 2108 determines whether the gear is in the reverse (R) position (S1408). In a case where the gear is in the R position (Yes in S1408), safety determiner 2108 instructs ADAS ECU 200a to stop parking assistance and notifies the driver that the parking assistance will be stopped (S1409). In a case where the gear is not in the R position (No in S1408), safety determiner 2108 completes the processing for the safety determination.

In a case where the communication having caused the anomaly alert is not a communication with ADAS ECU 200a (No in S1402), safety determiner 2108 determines whether the communication having caused the anomaly alert is a communication with IVI ECU 200b (S1410). In a case where the communication having caused the anomaly alert is a communication with IVI ECU 200b (Yes in S1410), safety determiner 2108 determines whether the gear is in the reverse (R) position (S1411). In a case where the gear is in the R position (Yes in S1411), safety determiner 2108 instructs DPI rule generator 2105A to generate a DPI rule for rear-view display monitoring (S1412).

In a case where the communication having caused the anomaly alert is not a communication with IVI ECU 200b (No in S1410) or in a case where the gear is not in the R position (No in S1411), safety determiner 2108 completes the processing for the safety determination. In a case where there is no anomaly alert from flow-based anomaly detector 104 (No in S1401), safety determiner 2108 completes the processing for the safety determination.

### Flowchart of Processing for Generating DPI Rule for Security Monitoring

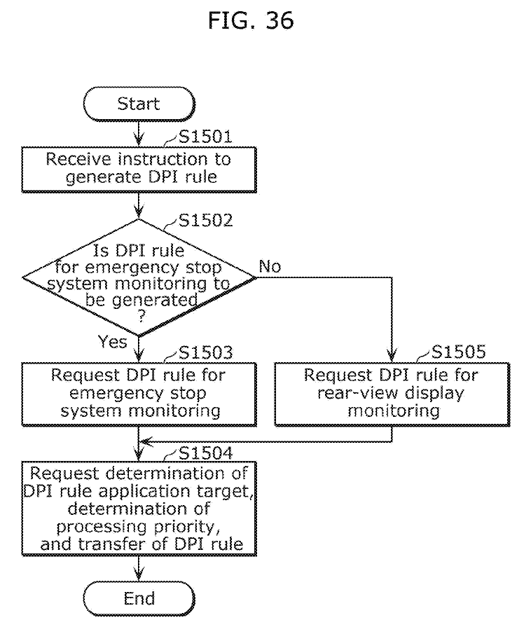

FIG. 36 is a flowchart of processing by DPI rule generator 2105A according to Embodiment 3. DPI rule generator 2105A receives an instruction to generate a DPI rule from safety determiner 2108 (S1501).

DPI rule generator 2105A determines whether the instruction from safety determiner 2108 is an instruction to generate a DPI rule for monitoring the emergency stop system (S1502). In a case where the instruction from safety determiner 2108 is an instruction to generate the DPI rule for monitoring the emergency stop system (Yes in S1502), DPI rule generator 2105A requests the DPI rule for monitoring the emergency stop system from security-monitoring-DPI-rule-list repository 2109 and obtains the DPI rule for monitoring the emergency stop system (S1503).

DPI rule generator 2105A requests DPI rule transferrer 2105B to determine an application target of the DPI rule for monitoring the emergency stop system, determine the processing priority of the DPI rule, and transfer the DPI rule to the application target (S1504) and completes the processing.

In a case where the instruction from safety determiner 2108 is not an instruction to generate the DPI rule for monitoring the emergency stop system (No in S1502), DPI rule generator 2105A requests a DPI rule for monitoring the rear-view display from security-monitoring-DPI-rule-list repository 2109 and obtains the DPI rule for monitoring the rear-view display (S1505). DPI rule generator 2105A then requests DPI rule transferrer 2105B to determine an application target of the DPI rule for monitoring the rear-view display, determine the processing priority of the DPI rule, and transfer the DPI rule to the application target (S1504) and completes the processing.

### One Example of Security Monitoring DPI Rules

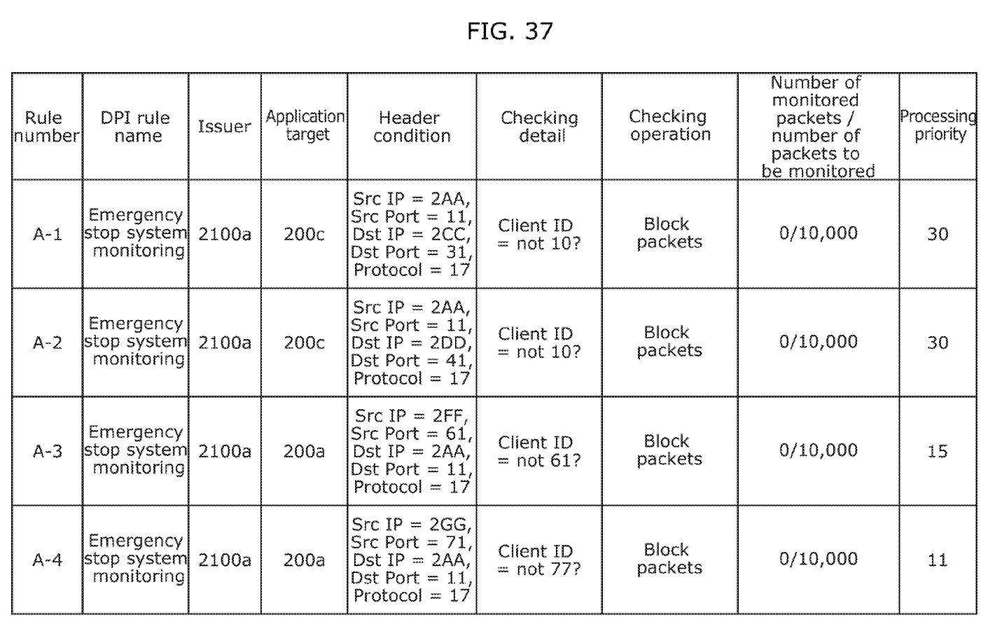

FIG. 37 is a table showing one example of generated DPI rules for security monitoring. The DPI rules shown in FIG. 37 are DPI rules for monitoring the emergency stop system that are generated in a case where an anomaly occurs in ADAS ECU 200a during the automated operating. Thus, the issuer of the DPI rules is zone ECU 2100a, which manages ADAS ECU 200a. The processing priorities of the DPI rules are calculated by DPI rule transferrer 2105B. The DPI rules are transferred by DPI rule transferrer 2105B.

### Other Variations

The present disclosure has been described thus far based on the above embodiments, but it goes without saying that the present disclosure is not limited to the above embodiments.

(1) In the above embodiments, the examples in which Ethernet is used as the in-vehicle networks have been described. However, the in-vehicle networks are not limited to Ethernet. For example, as each of the in-vehicle networks, Controller Area Network (CAN), Controller Area Network Flexible Data-Rate (CAN-FD), Ethernet, Local Interconnect Network (LIN), or FlexRay (registered trademark) may be used, or two or more of these may be used in combination.

(2) In the above embodiments, the collection of the flow information is performed by the zone ECUs. However, the collection need not be performed by the zone ECUs. The collection may be performed by a device other than the zone ECUs. For example, a head unit, a central ECU, an Ethernet switch, or the like may collect the flow information.

(3) In the above embodiments, a tuple including a source IP address, a destination IP address, a source port number, a destination port number, and a protocol number is used as the information for identifying a flow. However, the information for identifying a flow is not limited to these. For example, in addition to these or instead of at least some of these, a V-LAN ID, which is used in Virtual LAN, may be used as the information for identifying a flow. In a case where a CAN communication or the like is used, a CAN ID, which is an identifier of communication data, may be used as the information for identifying a flow. This makes the definition of a flow flexible, enabling a collection of the flow information suitable for a network.

(4) In the above embodiments, the packet count and the average arrival interval are used as the flow information used in the flow-base anomaly detection. However, the flow information used in the flow-base anomaly detection is not limited to these. For example, an average packet length, a timestamp, or the like may be used.

(5) In the above embodiments, the DPI, which is a payload-based anomaly detecting function, is used after the flow-base anomaly detection. However, an anomaly detecting function other than the DPI may be used. For example, an AI-based anomaly detecting function may be used.

(6) In the above embodiments, the ECUs discard DPI rules as appropriate based on results of monitoring performed by their DPI units. However, the zone ECUs may command the ECUs to discard DPI rules depending on circumstances.

(7) In the above embodiments, a DPI rule is discarded in a case where a specified number of packets have been monitored. However, the condition for discarding a DPI rule is not limited to this. For example, a DPI rule may be discarded in a case where a given time period has elapsed from the application of the DPI rule, or a DPI rule with the lowest priority of monitoring may be discarded first in a case where the number of DPI rules applied to the DPI unit exceeds a specified number.

(8) In the above embodiments, a DPI rule is applied to a source ECU or a destination ECU in a case where communication packets are encrypted. However, a DPI rule may be applied to another ECU including one of the zone ECUs as long as the other ECU is capable of decrypting the encrypted packets.

(9) In the above embodiments, the examples in which the DPI rule for security monitoring is applied in a case where the flow-based anomaly detector detects an anomaly in a communication involving the ADAS ECU and the IVI ECU have been described. However, communications to be subjected to the anomaly detection are not limited to this. For example, substantially the same processing may be applied in a case where an anomaly is detected in a communication involving any control system ECU or sensor system ECU and any other control system ECU or sensor system ECU. Substantially the same processing may be applied in a case where two or more anomalies that are the combination thereof are detected.

(10) In the above embodiments, the gear shifting and the automated operating are referred to as the vehicle state. However, the vehicle state to be referred to is not limited to these. For example, the vehicle state to be referred to may include at least one of automated parking, cruise controlling, software updating, vehicle diagnosing, or Internet communication connecting. In addition, with reference to such a vehicle state, at least one of generating, adding, changing, enabling, or disabling a DPI rule may be performed.

(11) In the above embodiments, an application target of a DPI rule is set based on the number of packets processed by the DPI unit. However, the method for setting an application target of a DPI rule is not limited to this. For example, an application target of a DPI rule may be determined based on a result of the anomaly detection by the flow-based anomaly detector. For example, in a case where the flow-based anomaly detector detects a flooding attack, a priority is given to the application of a DPI rule to a zone ECU close to a source ECU. This enables the zone ECU to perform processing for dropping an anomalous packet in a case where an anomaly is detected by the DPI unit.

(12) Some or all of the constituent elements included in each of the devices according to the above embodiments may be configured from a single system Large Scale Integration (LSI). A system LSI is a super-multifunctional LSI manufactured with a plurality of components integrated on a single chip, and is specifically a computer system configured of a microprocessor, Read-Only Memory (ROM), and Random-Access Memory (RAM), for example. A computer program is recorded in the RAM. The system LSI achieves its function as a result of the microprocessor operating according to the computer program. Furthermore, each unit of the constituent elements included in each of the devices described above may be individually configured into a single chip, or some or all of the units may be configured into a single chip. Moreover, although a system LSI is mentioned here, the integrated circuit can also be called an IC, LSI, super LSI, and ultra LSI, depending on the level of integration. Furthermore, the method of circuit integration is not limited to LSI, and implementation through a dedicated circuit or a general-purpose processor is also possible. A Field Programmable Gate Array (FPGA) which allows programming after LSI manufacturing or a reconfigurable processor which allows reconfiguration of the connections and settings of the circuit cells inside the LSI may also be used. In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(13) Some or all of the constituent elements included in each of the devices described above may be implemented as a single module or an IC card that can be inserted into and removed from the device. The IC card or the module is a computer system made up of a microprocessor, ROM, RAM, and so on. The IC card or the module may include the aforementioned super-multifunctional LSI. The IC card or the module achieves its functions as a result of the microprocessor operating according to the computer program. The IC card and the module may be tamper-proof.

(14) Another aspect of the present disclosure may be a program (computer program) for implementing the anomaly detection method using a computer or may be a digital signal of the computer program. Furthermore, still another aspect of the present disclosure may be a recording medium capable of reading a computer program or a digital signal by a computer, such as a flexible disk, a hard disk, a Compact Disc Read-Only Memory (CD-ROM), a Magneto-Optical disc (MO), a Digital Versatile Disc (DVD), a DVD-ROM, a DVD-RAM, a Blu-ray (registered trademark) Disc (BD), or semiconductor memory, for example. Furthermore, still another aspect of the present disclosure may be the digital signal recorded on such a recording medium. Furthermore, still another aspect of the present disclosure may be implemented by transmitting the computer program or the digital signal via an electrical communication line, a wireless or wired communication line, a network represented by the Internet, data broadcasting, or the like. Furthermore, still another aspect of the present disclosure may be a computer system including a microprocessor and memory. The memory may have the computer program recorded thereon, and the microprocessor may operate according to the computer program. Moreover, by transferring the recording medium having the program or the digital signal recorded thereon or by transferring the program or the digital signal via the network or the like, the present disclosure may be implemented by a different independent computer system.

(15) Forms configured by arbitrarily combining constituent elements and functions in the above embodiments and the above variations are included within the scope of the present disclosure.

### INDUSTRIAL APPLICABILITY

The present disclosure is useful for a device that detects an anomaly in a communication and for a method for detecting an anomaly in a communication in an in-vehicle network system.

1. An anomaly detection method that is performed by a higher electronic control unit in an in-vehicle network, the in-vehicle network having a hierarchical structure including a higher network and a lower network, the higher network including one or more higher electronic control units including the higher electronic control unit, the lower network including one or more lower electronic control units, the anomaly detection method comprising:
collecting flow information including statistical information for each flow, the flow being classified based on header information of each of messages received at a predetermined observation point in the in-vehicle network;
performing anomaly detection based on the flow information; and
performing one of generating, adding, deleting, changing, enabling, or disabling of a Deep Packet Inspection (DPI) rule based on a result of the anomaly detection, wherein
the DPI rule is used in message monitoring by the one or more lower electronic control units, and
the DPI rule indicates (i) a condition for header information and payload information that are included in a message, and (ii) processing to be performed when a message satisfying the condition is received.

2. The anomaly detection method according to claim 1, wherein
the flow information includes, for each flow, information on a quantity of the messages received, and
the anomaly detection method further comprises:
determining, based on the information, a processing priority for each of one or more DPI rules including the DPI rule, the processing priority indicating a processing order in the message monitoring.

3. The anomaly detection method according to claim 2, further comprising:
determining, based on a detail of an anomaly detected by the anomaly detection and a total number of messages to be monitored per time unit, a time period in which the message monitoring under the DPI rule is to be enabled or a maximum number of messages to be subjected to the message monitoring under the DPI rule.

4. The anomaly detection method according to claim 1, wherein
the DPI rule indicates service information or client information that is included in a message sent or received between the one or more lower electronic control units, and
in the message monitoring, when service information or client information in a message does not match the service information or the client information indicated in the DPI rule, the message is dropped.

5. The anomaly detection method according to claim 1, further comprising:
adding, changing, enabling, or disabling the DPI rule based on a result of the message monitoring that is outputted from a corresponding one of the one or more lower electronic control units.

6. The anomaly detection method according to claim 1, further comprising:
adding, changing, enabling, or disabling the DPI rule based on the result of the anomaly detection and a vehicle state, the vehicle state including at least one of gear shifting, automatic operating, automatic parking, cruise controlling, software updating, vehicle diagnosing, or Internet communication connecting.

7. The anomaly detection method according to claim 6, further comprising:
determining the processing to be performed indicated in the DPI rule based on the vehicle state of one lower electronic control unit among the one or more lower electronic control units, the one lower electronic control unit being a source or a destination of a message determined to be anomalous in the anomaly detection.

8. The anomaly detection method according to claim 1, further comprising:
selecting, from the one or more lower electronic control units, a first electronic control unit that is a source of a target message to be monitored under the DPI rule and a second electronic control unit that is a destination of the target message;
selecting at least one third electronic control unit from the one or more higher electronic control units, the at least one third electronic control unit being disposed, in the hierarchical structure, between the first electronic control unit and the second electronic control unit in the hierarchical structure, the at least one third electronic control unit being an electronic control unit through which the target message passes between the first electronic control unit and the second electronic control unit; and
applying the DPI rule to an electronic control unit having a smallest processing load in message processing, from among the first electronic control unit selected, the second electronic control unit selected, and the at least one third electronic control unit selected.

9. The anomaly detection method according to claim 8, further comprising:
calculating, based on the flow information, a communication traffic of each of the first electronic control unit, the second electronic control unit, and the at least one third electronic control unit; and
calculating the processing loads from the communication traffic and one or more DPI rules enabled in at least one of the one or more lower electronic control units, the one or more DPI rules each being the DPI rule.

10. The anomaly detection method according to claim 8, further comprising:
applying the DPI rule to a third electronic control unit that is closest, in the hierarchical structure, to the first electronic control unit among the at least one third electronic control unit, when a detail of an anomaly detected by the anomaly detection indicates an anomaly that places a load on the in-vehicle network.

11. The anomaly detection method according to claim 1, further comprising:
monitoring a message under the DPI rule by the higher electronic control unit.

12. An anomaly detection device that is included in a higher electronic control unit in an in-vehicle network, the in-vehicle network having a hierarchical structure including a higher network and a lower network, the higher network including one or more higher electronic control units including the higher electronic control unit, the lower network including one or more lower electronic control units, the anomaly detection device comprising:
a collector that collects flow information including statistical information for each flow, the flow being classified based on header information of each of messages received at a predetermined observation point in the in-vehicle network;
an anomaly detector that performs anomaly detection based on the flow information; and
a controller that performs one of generating, adding, deleting, changing, enabling, or disabling of a Deep Packet Inspection (DPI) rule based on a result of the anomaly detection, wherein
the DPI rule is used in message monitoring by the one or more lower electronic control units, and
the DPI rule indicates (i) a condition for header information and payload information that are included in a message, and (ii) processing to be performed when a message satisfying the condition is received.

13. A computer-readable recording medium having recorded thereon a program for causing a computer to execute the anomaly detection method according to claim 1.
